(19) United States
(12) Patent Application Publication
(10) Pub. No.: US 2025/0263856 A1
(43) Pub. Date: Aug. 21, 2025

(54) UNCONVENTIONAL PHASE JANUS NANOSTRUCTURES FOR ELECTROCATALYTIC CARBON DIOXIDE REDUCTION

(71) Applicant: City University of Hong Kong, Kowloon (HK)

(72) Inventors: Zhanxi Fan, Kowloon (HK); Yangbo Ma, Kowloon (HK)

(21) Appl. No.: 18/823,928

(22) Filed: Sep. 4, 2024

Related U.S. Application Data
(60) Provisional application No. 63/555,171, filed on Feb. 19, 2024.

(51) Int. Cl. C25B 11/081; C25B 1/23

(52) U.S. Cl. CPC C25B 11/081; C25B 1/23

(57) ABSTRACT

A nanomaterial includes an Au nanostructure; and a Cu nanostructure provided with the Au nanostructure; wherein each of the Au nanostructure and the Cu nanostructure is in the form of a heterophase. The method for preparing the nanomaterial is also addressed.

### TECHNICAL FIELD

The present invention relates to a nanomaterial, for example, particularly, but not exclusively, a nanomaterial comprising an Au nanostructure and a Cu nanostructure where each of which is in the form of a heterophase. The present invention also relates to a method for preparing the nanomaterial and to the use of the nanomaterial, particularly, in an electrochemical carbon dioxide reduction reaction.

### BACKGROUND OF THE INVENTION

Since the Industrial Revolution, the carbon dioxide (CO₂) concentration in Earth's atmosphere has dramatically increased by around 50% (from about 280 to 420 ppm), which urgently needs to be addressed due to its serious negative influences on the global ecosystem and environment. Among different approaches, electrochemical CO₂ reduction reaction (CO₂RR), which can utilize renewable electricity as the power source, is able to convert the over-accumulated CO₂ into value-added chemicals and fuels and thus holds great promise to achieve carbon neutrality. In particular, the multi-carbon (C₂₊) products of CO₂RR are more desirable as they have much higher energy content and larger economic value than the single-carbon (C₁) ones.

Copper (Cu) is believed to be the most distinctive catalyst for C₂₊ production because of its suitable adsorption strength towards the key intermediates in CO₂RR. To date, a series of materials design strategies have been applied on Cu-based nanomaterials to improve their catalytic performance towards C₂₊ generation, including the fine control of facet, strain, defect, composition, size, and dimension. However, all these aforementioned materials modification efforts are based on the conventional phase of Cu, i.e., face-centered cubic (fcc).

There are reports on unconventional phase metal nanomaterials such as unconventional phase single metals (e.g., 4H gold (Au), 2H cobalt, fcc ruthenium) and bimetallic alloys (e.g., 2H platinum-nickel, 2H nickel-iron, body-centered cubic palladium-copper), but the synthesis of unconventional phase Cu-based heteronanomaterials, particularly those with site-selective growth of Cu on a template/base/substrate material such as unconventional phase Au-based nanomaterials, remains a challenge.

The invention seeks to eliminate or at least to mitigate such problems by providing a new or otherwise an improved site-selective growth Au—Cu nanomaterial.

### SUMMARY OF THE INVENTION

In a first aspect of the present invention, there is provided a nanomaterial comprising: an Au nanostructure; and a Cu nanostructure provided with the Au nanostructure; wherein each of the Au nanostructure and the Cu nanostructure is in the form of a heterophase.

Optionally, the Cu nanostructure is provided on and above the Au nanostructure.

It is optional that both the Au nanostructure and the Cu nanostructure are in the form of a fcc-2H-fcc heterophase structure.

Optionally, the Cu nanostructure covers a first portion of the Au nanostructure.

It is optional that a second portion of the Au nanostructure is covered by a surfactant.

In an optional embodiment, the Au nanostructure is in the form of a fcc-2H-fcc Au nanorod.

Optionally, the fcc-2H-fcc Au nanorod has a first portion being covered by a fcc-2H-fcc Cu nanostructure.

It is optional that the fcc-2H-fcc Au nanorod and the fcc-2H-fcc Cu nanostructure are arranged in a substantially lattice-matching manner.

Optionally, the fcc-2H-fcc Au nanorod includes a second portion at least partly covered by a surfactant.

It is optional that the surfactant comprises any one of oleylamine and dodecylamine.

In an optional embodiment, the fcc-2H-fcc Au nanostructure and the fcc-2H-fcc Cu nanostructure are arranged in the form of a Janus nanostructure.

Optionally, the first portion of fcc-2H-fcc Au nanorod is circumferentially covered by the fcc-2H-fcc Cu nanostructure.

It is optional that the first portion is arranged between two second portions on the fcc-2H-fcc Au nanorod, and at least one of the two second portions is at least partly covered by the surfactant.

Optionally, at least one of the two second portions is at least partly covered by fcc Cu atoms of the fcc-2H-fcc Cu nanostructure.

In an optional embodiment, the fcc-2H-fcc Au nanorod and the fcc-2H-fcc Cu nanostructure are arranged in the form of a co-axial heteronanostructure.

Optionally, the fcc-2H-fcc Au nanorod is enclosed by the fcc-2H-fcc Cu nanostructure.

In an optional embodiment, the fcc-2H-fcc Au nanorod and the fcc-2H-fcc Cu nanostructure are arranged in the form of a fcc-2H-fcc Au—Cu core-shell nanostructure. In a second aspect of the present invention, there is provided a method for preparing the nanomaterial in accordance with the first aspect, comprising the steps of: a) providing a reaction mixture comprising a fcc-2H-fcc Au nanostructure, a reductant, and a copper precursor; b) heating the reaction mixture for a predetermined time, followed by cooling the reaction mixture to room temperature; and c) isolating the nanomaterial from the reaction mixture.

Optionally, the reaction mixture further includes a surfactant.

It is optional that the reaction mixture is provided by adding the copper precursor, at an elevated temperature, to a solution mixture including the fcc-2H-fcc Au nanostructure, the surfactant, and the reductant at a predetermined rate.

Optionally, the reductant comprises any one of 1,2-hexanediol, 1,2-hexadecanediol and 1,2-butanediol.

It is optional that the surfactant comprises a mixture of oleylamine and dodecylamine.

Optionally, oleylamine and dodecylamine have a volume ratio of about 2:3.

It is optional that the copper precursor comprises copper acetylacetone.

In an optional embodiment, the copper precursor is added to the solution mixture at a rate of about 0.094 mL min⁻¹ when the reductant comprises 1,2-hexanediol.

In an optional embodiment, the copper precursor is added to the solution mixture at a rate of about 0.062 mL min⁻¹ when the reductant comprises 2-hexadecanediol.

In an optional embodiment, the copper precursor is added to the solution mixture at a rate of about 0.5 mL s⁻¹ when the reductant comprises 1,2-butanediol.

It is optional that the elevated temperature is about 110° C. to about 130° C.

Optionally, the fcc-2H-fcc Au nanostructure is provided in the form of a fcc-2H-fcc Au nanorod.

In an optional embodiment, the method is a seeded growth method.

In a third aspect of the present invention, there is provided a catalyst for use in electrochemical carbon dioxide reduction reaction, comprising the nanomaterial in accordance with the first aspect of the present invention.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The invention will now be more particularly described, by way of example only, with reference to the accompanying drawings, in which:

FIG. 1 shows the schematic illustration for the site-selective growth of Cu on fcc-2H-fcc Au NRs to form the unconventional phase Au—Cu heteronanostructures in accordance with the embodiments of the present invention. HDO, 1,2-hexanediol; HDD, 1,2-hexadecanediol; BDO, 1,2-butanediol; Cu(acac) 2, copper acetylacetonate;

FIG. 2A shows the TEM image of as-synthesized fcc-2H-fcc Au NRs, with a scale of 50 nm;

FIG. 2B shows the TEM image of as-synthesized fcc-2H-fcc Au NRs, with a scale of 20 nm;

FIG. 3A shows the statistical analysis of the length of the as-synthesized fcc-2H-fcc Au NRs;

FIG. 3B shows the statistical analysis of the width of the as-synthesized fcc-2H-fcc Au NRs;

FIG. 4A shows the typical HRTEM image of fcc-2H-fcc Au NRs;

FIG. 4B shows a crystal model of the typical fcc-2H-fcc Au NR, viewed along the [110]₅/[101]_{f} zone axes;

FIG. 5 shows the XRD pattern of the as-synthesized fcc-2H-fcc Au NRs. The characteristic peaks of 2H and fcc phases are marked in the XRD pattern, confirming the fcc-2H-fcc heterophase of the obtained Au NRs;

FIG. 6 shows the XPS spectrum of fcc-2H-fcc Au NRs, indicating the metallic state of Au in the fcc-2H-fcc NRs;

FIG. 7 shows the EDS analysis of the composition of fcc-2H-fcc Au—Cu heteronanostructures, where fcc-2H-fcc Au—Cu JNSs, fcc-2H-fcc Au—Cu CAHs and fcc-2H-fcc Au—Cu CSNs have the Au/Cu atomic ratios of 47.38/52.62, 37.23/62.77 and 18.02/81.98, respectively;

FIG. 8A shows the TEM image of fcc-2H-fcc Au—Cu JNSs;

FIG. 8B shows the HAADF-STEM image of fcc-2H-fcc Au—Cu JNSs;

FIG. 8C shows the definition of the thickness of Cu domain of fcc-2H-fcc Au—Cu JNSs;

FIG. 8D shows the statistical analysis of the thickness of Cu domain of fcc-2H-fcc Au—Cu JNSs;

FIG. 9 shows the spherical aberration-corrected high-resolution HAADF-STEM image of Au/Cu interface in the fcc-2H-fcc Au—Cu JNS;

FIG. 10A shows the schematic illustration of the unit cell (top panel) and (101)_{f} plane (bottom panel) for the conventional fcc phase;

FIG. 10B shows the schematic illustration of the unit cell (top panel) and (110)ₕ plane (bottom panel) of the unconventional 2H phase;

FIG. 11 the HAADF-STEM image and the corresponding EDS elemental mapping of a typical fcc-2H-fcc Au—Cu JNS;

FIG. 12 shows the crystal model of the obtained fcc-2H-fcc Au—Cu JNSs, viewed along the [110]ₕ/[101]_{f} zone axes;

FIG. 13A shows the TEM image of fcc-2H-fcc Au NRs dispersed in EG, with a scale of 20 nm;

FIG. 13B shows the TEM image of fcc-2H-fcc Au—Cu JNSs obtained by using EG as the solvent, with a scale of 50 nm;

FIG. 14A shows the TEM image of the product obtained using an injection speed of Cu precursor at 1.86 mL min⁻¹ upon the synthesis of fcc-2H-fcc Au—Cu JNSs, with a scale of 20 nm;

FIG. 14B shows the TEM image of the product obtained using an injection speed of Cu precursor at 1.40 mL min⁻¹ upon the synthesis of fcc-2H-fcc Au—Cu JNSs, with a scale of 20 nm;

FIG. 14C shows the TEM image of the product obtained using an injection speed of Cu precursor at 0.064 mL min⁻¹ upon the synthesis of fcc-2H-fcc Au—Cu JNSs, with a scale of 20 nm;

FIG. 14D shows the TEM image of the product obtained using an injection speed of Cu precursor at 0.031 mL min⁻¹ upon the synthesis of fcc-2H-fcc Au—Cu JNSs, with a scale of 20 nm;

FIG. 15A shows the TEM image of the product obtained using a concentration of Cu precursor at 5.20 mM upon the synthesis of fcc-2H-fcc Au—Cu JNSs, with a scale of 20 nm;

FIG. 15B shows the TEM image of the product obtained using a concentration of Cu precursor at 9.20 mM upon the synthesis of fcc-2H-fcc Au—Cu JNSs, with a scale of 20 nm;

FIG. 15C shows the TEM image of the product obtained using a concentration of Cu precursor at 17.20 mM upon the synthesis of fcc-2H-fcc Au—Cu JNSs, with a scale of 20 nm;

FIG. 15D shows the TEM image of the product obtained using a concentration of Cu precursor at 20.40 mM upon the synthesis of fcc-2H-fcc Au—Cu JNSs, with a scale of 20 nm;

FIG. 16A shows the TEM image of fcc-2H-fcc Au—Cu CAHs, with a scale of 50 nm;

FIG. 16B shows the HAADF-STEM image of fcc-2H-fcc Au—Cu CAHs, with a scale of 10 nm;

FIG. 16C shows the definition of the thickness of Cu domain in fcc-2H-fcc Au—Cu CAHs;

FIG. 16D shows the statistical analysis of the thickness of Cu domain in fcc-2H-fcc Au—Cu CAHs;

FIG. 17 shows the spherical aberration-corrected high-resolution HAADF-STEM image of Au/Cu interface in the fcc-2H-fcc Au—Cu CAH;

FIG. 18 shows the HAADF-STEM image and the corresponding EDS elemental mapping of a typical fcc-2H-fcc Au—Cu CAH;

FIG. 19 shows the crystal model of the obtained fcc-2H-fcc Au—Cu CAHs, viewed along the [110]₅/[101]_{f} zone axes;

FIG. 20A shows the TEM image of fcc-2H-fcc Au—Cu CSNs, with a scale of 50 nm;

FIG. 20B shows the HAADF-STEM image of fcc-2H-fcc Au—Cu CSNs, with a scale of 10 nm;

FIG. 20C shows the definition of the thickness of Cu domain in fcc-2H-fcc Au—Cu CSNs;

FIG. 20D shows the statistical analysis of the thickness of Cu domain in fcc-2H-fcc Au—Cu CSNs;

FIG. 21 shows the spherical aberration-corrected high-resolution HAADF-STEM image of Au/Cu interface in the fcc-2H-fcc Au—Cu CSN;

FIG. 22 shows HAADF-STEM image and the corresponding EDS elemental mapping of a typical fcc-2H-fcc Au—Cu CSN;

FIG. 23 shows the crystal model of the obtained fcc-2H-fcc Au—Cu CSNs, viewed along the [110]₅/[101]_{f} zone axes;

FIG. 24 shows the XRD patterns of the as-synthesized fcc-2H-fcc Au—Cu heteronanostructures. The characteristic peaks of 2H phase, i.e., (100)ₕ and (101)ₕ marked by the black arrows, are well presented in the XRD patterns;

FIG. 25A shows the chemical state analysis of the as-synthesized fcc-2H-fcc Au—Cu heteronanostructures by XPS. The XPS spectra of the Au 4f doublet suggest the metallic states of Au in the as-synthesized fcc-2H-fcc Au—Cu heteronanostructures;

FIG. 25B shows the chemical state analysis of the as-synthesized fcc-2H-fcc Au—Cu heteronanostructures by XPS. The XPS spectra of the Cu 2p doublet suggest the metallic states of Au and Cu in the as-synthesized fcc-2H-fcc Au—Cu heteronanostructures;

FIG. 26A shows the normalized XANES spectra of Cu K-edge in the as-prepared fcc-2H-fcc Au—Cu heteronanostructures, CuO, Cu₂O and Cu foil;

FIG. 26B shows the Fourier transform of Cu K-edge EXAFS spectra of fcc-2H-fcc Au—Cu heteronanostructures, CuO, Cu₂O and Cu foil;

FIG. 27A shows the fitting results of k2-weighted R space at Cu K-edge for Cu foil corresponding to FIG. 26B;

FIG. 27B shows the fitting results of k2-weighted R space at Cu K-edge for fcc-2H-fcc Au—Cu JNSs corresponding to FIG. 26B;

FIG. 27C shows the fitting results of k2-weighted R space at Cu K-edge for fcc-fcc-2H-fcc Au—Cu CAHs corresponding to FIG. 26B;

FIG. 27D shows the fitting results of k2-weighted R space at Cu K-edge for fcc-fcc-2H-fcc Au—Cu CSNs corresponding to FIG. 26B;

FIG. 28 is a table summarizing fitting results of the Cu K-edge EXAFS spectra for the Cu foil, fcc-2H-fcc Au—Cu JNSs, fcc-2H-fcc Au—Cu CAHs, and fcc-2H-fcc Au—Cu CSNs corresponding to FIGS. 27A to 27D;

FIG. 29 shows the normalized XANES spectra of Au L3-edge in fcc-2H-fcc Au—Cu heteronanostructures, fcc-2H-fcc Au NRs and Au foil;

FIG. 30 shows the Fourier transform of Au L3-edge EXAFS spectra of fcc-2H-fcc Au—Cu heteronanostructures, fcc-2H-fcc Au NRs and Au foil;

FIG. 31A shows the fitting results of k2-weighted R space at Au L3-edge for Au foil corresponding to FIG. 30;

FIG. 31B shows the fitting results of k2-weighted R space at Au L3-edge for fcc-2H-fcc Au NRs corresponding to FIG. 30;

FIG. 31C shows the fitting results of k2-weighted R space at Au L3-edge for fcc-2H-fcc Au—Cu CAHs corresponding to FIG. 30;

FIG. 31D shows the fitting results of k2-weighted R space at Au L3-edge for fcc-2H-fcc Au—Cu CAHs corresponding to FIG. 30;

FIG. 31E shows the fitting results of k2-weighted R space at Au L3-edge for fcc-2H-fcc Au—Cu CSNs corresponding to FIG. 30;

FIG. 32 is a table summarizing the fitting results of the Au L3-edge EXAFS spectra for the Au foil, fcc-2H-fcc Au NRs, fcc-2H-fcc Au—Cu JNSs, fcc-2H-fcc Au—Cu CAHs, and fcc-2H-fcc Au—Cu CSNs corresponding to FIGS. 31A to 31E;

FIG. 33 shows the wavelet transform of Cu K-edge EXAFS spectra for fcc-2H-fcc Au—Cu heteronanostructures and Cu foil (left), and for fcc-2H-fcc Au—Cu heteronanostructures and Au foil (right);

FIG. 34A shows the TEM image of the commercial fcc Cu NPs, with a scale of 100 nm;

FIG. 34B shows the TEM image of the commercial fcc Cu NPs, with a scale of 20 nm;

FIG. 34C shows the Selected-area electron diffraction (SAED) pattern of the commercial fcc Cu NPs;

FIG. 34D shows the XRD pattern of the commercial fcc Cu NPs;

FIG. 35 shows the EDS spectrum which illustrates the composition of Au+Cu mixture with an Au/Cu atomic ratio of 46.70/53.30, close to that of fcc-2H-fcc Au—Cu JNSs (47.38/52.62);

FIG. 36A shows the FEs of major CO₂-reduction products obtained on fcc-2H-fcc Au—Cu JNSs;

FIG. 36B shows the FEs of major CO₂-reduction products obtained on fcc-2H-fcc Au—Cu CAHs;

FIG. 36C shows the FEs of major CO₂-reduction products obtained on fcc-2H-fcc Au—Cu CSNs;

FIG. 37A shows the detailed CO₂RR performance of fcc-2H-fcc Au—Cu JNSs corresponding to FIG. 36A. The FE of all CO₂RR products when using fcc-2H-fcc Au—Cu JNSs as the catalyst;

FIG. 37B shows the detailed CO₂RR performance of fcc-2H-fcc Au—Cu CAHs corresponding to FIG. 36B. The FE of all CO₂RR products when using fcc-2H-fcc Au—Cu CAHs as the catalyst;

FIG. 37C shows the detailed CO₂RR performance of fcc-2H-fcc Au—Cu CSNs corresponding to FIG. 36B. The FE of all CO₂RR products when using fcc-2H-fcc Au—Cu CSNs as the catalyst;

FIG. 38 shows the CO₂RR performance of commercial fcc Cu NPs. The FE of the major CO₂RR products obtained on commercial fcc Cu NPs under different potentials;

FIG. 39 shows the CO₂RR performance of Au+Cu mixture. The FE of the major CO₂RR products obtained on the Au+Cu mixture under different potentials;

FIG. 40 shows the CO₂RR performance of fcc-2H-fcc Au NRs. The FE of the major CO₂RR products obtained on fcc-2H-fcc Au NRs under different potentials;

FIG. 41A shows the cathode energy efficiency of C₂H₄ on the fcc-2H-fcc Au—Cu JNSs, fcc-2H-fcc Au—Cu CAHs, fcc-2H-fcc Au—Cu CSNs, commercial fcc Cu NPs and Au+Cu mixture under different potentials. Note that the cathode energy efficiency (CEE) of C₂H₄ was calculated by using the equation of CEE_{C2H4}=(E_{ox°}−E_{red°})/(Eₒₓ−E_{red})×FE_{C2H4} by coupling CO₂RR with anodic oxygen evolution reaction (O₂+4H⁺+4e⁻′2H₂O). Here, E_{red} and Eₒₓ are the thermodynamic potentials of CO₂RR to C₂H₄ (0.08 V vs RHE) and oxygen evolution reaction (1.23 V vs RHE), respectively. The E_{red} and Eₒₓ are the applied potentials in the cathode and anode of the H-type cell, respectively. For the calculation of the half-cell CEE, the anode reaction was assumed to occur with an overpotential of 0 V, i.e., Eₒₓ=1.23 V (vs RHE);

FIG. 41B shows the LSV curves of fcc-2H-fcc Au—Cu JNSs, fcc-2H-fcc Au—Cu CAHs, fcc-2H-fcc Au—Cu CSNs and commercial fcc Cu NPs for comparing their electrocatalytic activity in CO₂RR;

FIG. 42 shows the comparison of the FEs of C₂₊ products and C₂H₄ generated on the fcc-2H-fcc Au—Cu heteronanostructures, commercial fcc Cu NPs and Au+Cu mixture at −1.1 V (vs RHE);

FIG. 43A is a table comparing the CO₂RR performance of the fcc-2H-fcc Au—Cu heteronanostructures in this work with the reported Cu-based catalysts in H-type cell;

FIG. 43B is a table comparing the CO₂RR performance of the fcc-2H-fcc Au—Cu heteronanostructures in this work with the reported Cu-based catalysts in H-type cell corresponding to FIG. 43A;

FIG. 43C is a table comparing the CO₂RR performance of the fcc-2H-fcc Au—Cu heteronanostructures in this work with the previously reported Cu-based catalysts in H-type cell corresponding to FIGS. 43A and 43B;

FIG. 43D is a table comparing the CO₂RR performance of the fcc-2H-fcc Au—Cu heteronanostructures in this work with the previously reported Cu-based catalysts in H-type cell corresponding to FIGS. 43A to 43C;

FIG. 44 shows the comparison of the partial current density towards C₂₊ products in CO₂RR. The partial current density of C₂₊ products obtained on fcc-2H-fcc Au—Cu JNSs, fcc-2H-fcc Au—Cu CAHs, fcc-2H-fcc Au—Cu CSNs and commercial fcc Cu NPs;

FIG. 45 shows the comparison of the C₂₊/C₁ product ratios among fcc-2H-fcc Au—Cu heteronanostructures, commercial fcc Cu NPs and Au+Cu mixture at different potentials;

FIG. 46 shows the catalytic performance comparison of this work with the reported catalysts with similar heterostructures for CO₂RR in four aspects;

FIG. 47 shows the long-term catalytic stability evaluation of fcc-2H-fcc Au—Cu JNSs at the constant potential of −1.1 V (vs RHE). Vertical arrows that are pointing downwards: refreshing the electrolytes at these points;

FIG. 48A shows the TEM image of fcc-2H-fcc Au—Cu JNSs after 10 h CO₂ electrolysis. The white arrows in this panel show that fcc-2H-fcc Au—Cu JNSs can largely maintain the morphology and Janus nanostructure;

FIG. 48B shows the composition evaluation of fcc-2H-fcc Au—Cu JNSs after 10 h CO₂RR test;

FIG. 49 shows the HRTEM image of the Au/Cu interface in fcc-2H-fcc Au—Cu JNSs after the durability test, with (B) to (G) corresponding the fast Fourier transform (FFT) patterns of the selected areas marked in (A);

FIG. 50A shows the flow cell performance of fcc-2H-fcc Au—Cu JNSs: the FE of C₂H₄ and C₂₊ products along with the partial current density of C₂₊ products under different potentials;

FIG. 50B shows the total current density of fcc-2H-fcc Au—Cu JNSs in flow cell under different potentials;

FIG. 50C shows the specific FE of all the CO₂RR products of fcc-2H-fcc Au—Cu JNSs in flow cell under different potentials;

FIG. 51 is a table comparing the detected intermediates and corresponding band positions by the in-situ ATR-FTIR spectroscopy for CO₂RR from this work and the reported work;

FIG. 52A shows the in-situ ATR-FTIR spectra of fcc-2H-fcc Au—Cu JNSs under CO₂RR conditions;

FIG. 52B shows the in-situ ATR-FTIR spectra of commercial fcc Cu NPs under CO₂RR conditions;

FIG. 52C shows the in-situ ATR-FTIR spectra of Au+Cu mixture under CO₂RR conditions;

FIG. 53A shows the in-situ DEMS spectra of C₂H₄ production in CO₂RR on the fcc-2H-fcc Au—Cu JNSs, commercial fcc Cu NPs and Au+Cu mixture;

FIG. 53B shows in-situ DEMS spectra of CO production in CO₂RR on the fcc-2H-fcc Au—Cu JNSs, commercial fcc Cu NPs and Au+Cu mixture;

FIG. 53C shows the in-situ DEMS spectra of H₂ obtained on the fcc-2H-fcc Au—Cu JNSs, commercial fcc Cu NPs and Au+Cu mixture;

FIG. 53D shows the in-situ DEMS spectra of CH₄ obtained on the fcc-2H-fcc Au—Cu JNSs, commercial fcc Cu NPs and Au+Cu mixture;

FIG. 54A shows the electronic distributions of bonding and anti-bonding orbitals near Fermi level in 2H/fcc Au—Cu JNSs. Red balls=Cu; Yellow balls=Au; Blue isosurface=bonding orbitals; green isosurface=anti-bonding orbitals;

FIG. 54B shows the electronic distributions of bonding and anti-bonding orbitals near Fermi level in fcc Au—Cu JNSs. Red balls=Cu; Yellow balls=Au; Blue isosurface=bonding orbitals; green isosurface=anti-bonding orbitals;

FIG. 55A shows the PDOSs of 2H/fcc Au—Cu JNSs;

FIG. 55B shows the PDOSs of fcc Au—Cu JNSs;

FIG. 56A shows the site-dependent PDOSs of Cu-3d;

FIG. 56B shows the site-dependent PDOSs of Au-5d;

FIG. 57 shows the d-band center comparison;

FIG. 58 shows the PDOS comparison of key intermediates for C₂H₄ generation;

FIG. 59 shows the adsorption energies of CO₂;

FIG. 60 shows the adsorption energies of CO* at different positions;

FIG. 61 shows the reaction energy of C—C coupling on 2H Au—Cu and fcc Au—Cu; and

FIG. 62 shows the reaction energies of C₂H₄ formation on 2H Au—Cu and fcc Au—Cu.

### DETAILED DESCRIPTION OF OPTIONAL EMBODIMENT

As used herein, the forms “a”, “an”, and “the” are intended to include the singular and plural forms unless the context clearly indicates otherwise.

The words “example” or “exemplary” used in this invention are intended to serve as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A, X employs B, or X employs both A and B, then “X employs A or B” is satisfied under any of the foregoing instances.

As used herein, the phrase “about” is intended to refer to a value that is slightly deviated from the value stated herein. Examples have been described throughout the present disclosure.

Without wishing to be bound by theory, the inventors have, through their own research, trials, and experiments, devised that through delicately controlling the reduction kinetics and surfactant along with the concentration depletion strategy, the site-selective growth of unconventional heterophase Cu, such as fcc-2H-fcc Cu on unconventional heterophase phase Au nanostructure, such as fcc-2H-fcc Au nanorods (NRs) may be achieved. In particular, it is believed that the heterophase nanomaterials of the present invention may diversify the CO* adsorption configurations and decrease the overpotential for C₂₊ generation. In addition, the heterophase nanomaterials of the present invention may have an improved electroactivity of both Au and Cu sites as a result of the electronic modulation induced by the 2H phases, leading to stronger adsorption of CO₂ and CO and therefore an improved CO₂ electroreduction performance.

In some example embodiments, the heterophase nanomaterials of the present invention may exhibit the Faradaic efficiencies (FEs) of 50.2% to 55.5% and 70.3% to 84.3% towards ethylene (C₂H₄) and C₂₊ products at −1.1 V (vs reversible hydrogen electrode (RHE)), respectively. In some particular embodiments, the heterophase nanomaterials of the present invention may also deliver an industrial relevant partial current density of 220.80 mA cm⁻² and FE of 61.3% for C₂₊ production in flow cell.

In a first aspect of the present invention, there is provided a nanomaterial comprising: an Au nanostructure; and a Cu nanostructure provide with the Au nanostructure; wherein each of the Au nanostructure and the Cu nanostructure is in the form of a heterophase.

In some embodiments, the Cu nanostructure may be provided on and above the Au nanostructure. In some embodiments, the Cu nanostructure may be provided on and without fusing with the Au nanostructure. In some embodiments, the Cu nanostructure may be epitaxial grown on the Au nanostructure without fusing with the Au nanostructure. The Au nanostructure and the Cu nanostructure, particularly, are both in the form of a fcc-2H-fcc heterophase structure. Without wishing to be bound by theory, with the aforementioned structural arrangement/configuration, the Cu nanostructure and the Au nanostructure may therefore form a tandem catalyst for electrochemical CO₂ reduction reaction (CO₂RR), and the unconventional 2H phase of the Au nanostructure and the Cu nanostructure may be able to enhance the *CO/CO spillover efficiency, promoting C—C coupling for C₂₊ formation in CO₂RR. As such, the nanomaterial of the present invention may have an excellent CO₂RR performance, which will be illustrated in the later part of the present disclosure.

In some embodiments, the Cu nanostructure may cover a first portion of the Au nanostructure. In some particular embodiments, the Au nanostructure may have a second portion which is covered by a surfactant.

The Au nanostructure may be provided in various forms such as nanoparticle, nanobar, nanorod, nanotube, nanowire, nanoribbon, nanofilm, nanosheet, nanoplate, nanoflake and the like. In some particular embodiments, the Au nanostructure may be in the form of an Au nanorod, particularly of a heterophase Au nanorod, more particularly of a fcc-2H-fcc Au nanorod.

In the embodiments where the Au nanostructure is in the form of a fcc-2H-fcc Au nanorod, a first portion of the nanorod may be covered by a fcc-2H-fcc Cu nanostructure. In particular, the fcc-2H-fcc Au nanorod and the fcc-2H-fcc Cu nanostructure may be arranged in a substantially lattice-matching manner, or in other words, the fcc-2H-fcc Au nanorod and the fcc-2H-fcc Cu nanostructure are substantially lattice-matched. As used herein, the phrases “substantially lattice-matching” or “substantially lattice-matched” describes the arrangement of the fcc-2H-fcc Au nanorod and the fcc-2H-fcc Cu nanostructure is in a manner that their lattice parameters are substantially similar. For example, the unit cell of the 2H Cu of the fcc-2H-fcc Cu nanostructure may have a lattice spacing of about 2.03 Å to about 2.07 Å whereas the 2H Au of the fcc-2H-fcc Au nanorod may have a lattice spacing of about 2.33 Å to about 2.35 Å.

In some embodiments, the Au nanorod may also include a second portion at least partly covered by a surfactant. In particular, without wishing to be bound by theory, it is believed that the surfactant may be adsorbed on and covering the surface of the Au nanorod. Any initial Cu atoms (i.e., Cu seeds) deposited on a particular site of the Au nanorod would displace or cause the surfactant to detach from the Au nanorod. In other words, any site/portion of the Au nanorod that is provided/deposited/grown with the Cu seed or the Cu nanostructure would not be covered by the surfactant while any site/portion of the Au nanorod without the Cu seed or the Cu nanostructure would be covered by the surfactant. In some embodiments, the surfactant may be any one of oleylamine and dodecylamine.

In some embodiments, the fcc-2H-fcc Au nanostructure such as the fcc-2H-fcc Au nanorod and the fcc-2H-fcc Cu nanostructure may be arranged in the form of a Janus nanostructure. In these embodiments, the fcc-2H-fcc Cu nanostructure may be arranged on and above the longitudinal side of the fcc-2H-fcc Au nanostructure, thereby forming an asymmetric nanostructure/nanomaterial.

In some embodiments, the first portion of the fcc-2H-fcc Au nanorod is circumferentially covered by the fcc-2H-fcc Cu nanostructure. In these embodiments, for example, the first portion may be arranged between two second portions on the fcc-2H-fcc Au nanorod, and at least one of the two second portions may be at least partly covered by the surfactant as described herein. In particular, at least one of the two second portions may be at least partly covered by fcc Cu atoms of the fcc-2H-fcc Cu nanostructure. Yet in particular, any site/portion of the Au nanorod in these embodiments that is provided/deposited/grown with the Cu seed or the Cu nanostructure would not be covered by the surfactant while any site/portion of the Au nanorod without the Cu seed or the Cu nanostructure would be covered by the surfactant. In these embodiments, the fcc-2H-fcc Au nanorod and the fcc-2H-fcc Cu nanostructure is arranged in the form of a co-axial heteronanostructure.

In some embodiments, the fcc-2H-fcc Au nanorod may be enclosed by the fcc-2H-fcc Cu nanostructure. In these embodiments, the fcc-2H-fcc Au nanorod and the fcc-2H-fcc Cu nanostructure is arranged in the form of a fcc-2H-fcc Au—Cu core-shell nanostructure.

The method for preparing the nanomaterial as described herein will now be disclosed. The method as described herein may be a seeded growth method. Without wishing to be bound by theory, it is believed that, as compared with synthetic methods involving one-pot synthesis, such as wet-chemical synthesis, the seeded growth method may have a more better product control. In other words, the seeded-growth method may be easier to obtain a desired seed-growth product as compared with the synthetic methods involving one-pot synthesis, such as wet-chemical synthesis. The method as described herein may comprise the steps of: a) providing a reaction mixture comprising a fcc-2H-fcc Au nanostructure, a reductant, and a copper precursor; b) heating the reaction mixture for a predetermined time, followed by cooling the reaction mixture to room temperature; c) isolating the nanomaterial from the reaction mixture.

In some embodiments, the reaction mixture may further include a surfactant as described herein and the fcc-2H-fcc Au nanostructure may be provided in the form of a fcc-2H-fcc Au nanorod. In these embodiments, the reaction mixture may be provided by adding the copper precursor, at an elevated temperature, to a solution mixture including the fcc-2H-fcc Au nanostructure such as the fcc-2H-fcc Au nanorod as described herein, the surfactant as described herein, and the reductant at a predetermined rate.

In particular, it is believed that the surfactant may facilitate the dispersion of the Au nanostructure, minimizing the chance of aggregation of the Au nanostructure. In addition, without wishing to be bound by theory, the inventors have devised that the surfactant may play a role in modulating the reduction kinetics of the reductant acting on the Au nanostructure during the synthesis, thereby leading to various forms of nanostructured product as described herein. For example, in some embodiments, the disposition of the Cu atoms may be obstructed by the surfactant, thereby resulting in an asymmetric nanostructure as the final product.

In some embodiments, the surfactant may comprise a mixture of oleylamine and dodecylamine. In some example embodiments, the oleylamine and dodecylamine may have a volume ratio of about 2:3 such as 1.75:3, 1.78:3, 1.8:3, 1.85:3, 1.9:3, 1.94:3, 1.98:3, 2:3, 2.01:3, 2.1:3, 1.76:3.01, 1.82:3.1, 1.96:3.02, 2:3.05 and the like. Optionally or additionally, dodecylamine may be replaced with its derivatives such as, hexadecylamine, octadecylamine and the like. In some example embodiments, the copper precursor may comprise copper acetylacetone. In some example embodiments, the reductant may comprise any one of 1,2-hexanediol, 1,2-hexadecanediol and 1,2-butanediol.

Without wishing to be bound by theory, it is believed that by controlling the supply rate of the Cu atom (from the Cu precursor) to the solution mixture, it may lead to various forms of nanostructure as described herein. For example, it is believed that with a very high Cu atom supply rate (e.g., 1.40 mL min⁻¹ or higher), the overly supplied Cu atoms may fully cover the seeded Cu atoms in a short time, substantially leading to an Au@Cu core-shell nanostructure. It is also believed that, in contrast, with a very slow Cu atom supply rate (e.g., 0.062 mL min⁻¹ or lower), the Cu atom concentration may be not sufficient to nucleate before the Au nanostructure such as the Au nanorods aggregate together or sink, leading to a nanomaterial with the Au nanostructure being partly covered by the Cu nanostructure.

Accordingly, in some embodiments, the copper precursor may be added to the solution mixture at a rate of about 0.094 mL min⁻¹ (such as from 0.088 mL min-1 to 0.12 mL min⁻¹) when the reductant comprises 1,2-hexanediol. In these embodiments, it may lead to the Au—Cu Janus nanostructure as described herein.

In some other embodiments, the copper precursor may be added to the solution mixture at a rate of about 0.062 mL min⁻¹ (such as from 0.056 mL min-1 to 0.07 mL min⁻¹) when the reductant comprises 2-hexadecanediol. In these embodiments, it may lead to the Au—Cu co-axial heteronanostructure as described herein.

In yet some other embodiments, the copper precursor may be added to the solution mixture at a rate of about 0.5 mL min⁻¹ (such as from 0.2 mL min-1 to 1 mL min⁻¹) when the reductant comprises 1,2-butanediol. In these embodiments, it may lead to the Au—Cu core-shell nanostructure as described herein.

In some embodiments, the copper precursor may be added to the solution mixture at a temperature of about 110° C. to about 130° C. such as 108° C. to 130° C., 109° C. to 130° C., 108° C. to 132° C., 110° C. to 132° C., 112° C. to 130° C., 112° C. to 128° C., 115° C. to 125° C., 118° C. to 122° C. and the like. In some example embodiments, the copper precursor may be added to the solution mixture at a temperature of about 120° C.

The solution mixture may be prepared by isolating the fcc-2H-fcc Au nanostructure from a stock solution of the fcc-2H-fccAu nanostructure, such as by way of centrifugation, followed by adding the surfactant such as about 200 μL, and subsequently adding the reductant as described herein to the isolated fcc-2H-fcc Au nanostructure. Optionally or additionally, repeated sonication may be carried out to the solution mixture to improve the homogeneity of the solution mixture.

In step b), the reaction mixture may be heated at a temperature of about 120° C. for about, such as 2 min, followed by cooling the reaction mixture to room temperature, such as by way of an ice bath.

In step c), the nanomaterial as described herein may be isolated from the reaction mixture by washing the nanomaterial with suitable solvent such as n-hexane in some example embodiments. Optionally or additionally, the washing step may be repeated in accordance with practical needs. Optionally or additionally, the isolated nanomaterial may be stored in suitable liquid media, particularly inert liquid media such as n-hexane and the like, under a lowered temperature such as at about −4° C. to about 4° C.

Hereinafter, the present invention is described more specifically by way of examples, but the present invention is not limited thereto.

### EXAMPLES

### Materials

Potassium gold (III) chloride (KAuC14, 98%), Nafion (117 solution, 5 wt %), and commercial fcc Cu NPs (with size around 50 nm) were purchased from Sigma-Aldrich. Oleylamine (OAM, 80-90%), dodecylamine (DDA, 98%), 1,2-butanediol (BDO, >98% (GC)), 1,2-hexanediol (HDO, 98%), 1,2-hexadecanediol (HDD, 98%), copper acetylacetonate (Cu(acac) 2, 97%), isopropyl alcohol (IPA, AR, ≥99.5%), cyclohexane (>99%), and ethylene glycol (EG, >99% (GC)) were purchased from Shanghai Aladdin Bio-Chem Technology Co., Ltd. Ethanol (ACS Grade, Absolute) and n-hexane (ACS Grade, 99%) were purchased from Anaqua Global International Inc. Limited. Oxygen gas and CO₂ gas were purchased from Specialty Gas Engineering Company Limited. All the chemical reagents and materials were used as received without any further purification. Deionized (DI) water with a resistance of 18.2 MΩ cm was used in the experiments.

### Characterization

The TEM images were collected on a FEI Tecnai T12 TEM operated at 120 kV. The high-resolution TEM (HRTEM) images were taken on a JEOL 2100F operated at 200 kV. The spherical aberration-corrected HAADF-STEM images and the EDS elemental mappings were acquired by JEOL ARM200F operated at 200 kV with cold field emission gun and double hexapole Cs correctors (CEOS GmbH). The scanning electron microscopy (SEM) images were obtained by a Thermo Scientific Quattro S operated at 20 kV. XRD patterns were taken by SmartLab 9 kW (Rigaku) with a Cu Kα radiation (λ=1.5406 Å) source. XPS tests were conducted in a VG ESCALAB 220i-XL surface analysis system with a base vacuum lower than 10⁻⁹ Torr. XAS measurements were performed on the beamline 1W1B Beijing Synchrotron Radiation Facility in the transmission mode. The data processing was performed using the Athena and Artemis software packages. The loading amount of Cu was confirmed by an inductively coupled plasma optical emission spectrometry (ICP-OES, PerkinElmer, Optima 8000).

### Electrochemical CO₂RR Measurement in H-type Cell

### Preparation of the Working Electrode

The as-synthesized heteronanostructures (or catalysts) were first transferred from n-hexane to ethanol by gradually changing the volume ratio between n-hexane and ethanol during washing with centrifugation. Specifically, the catalyst was washed sequentially with a mixture of n-hexane and ethanol from 6:1 (v/v), 6:6 (v/v), and 1:6 (v/v), and finally by pure ethanol. After washing with pure ethanol, the catalyst was redispersed into ethanol. At this stage, the transfer of the catalysts from n-hexane to ethanol is completed. After measuring the concentration of Cu and/or Au by ICP-OES, an appropriate amount of the catalyst stock solution was centrifugated. In particular, the phrase the appropriate amount as used herein refers to 100 μg of Cu when the sample is pure fcc Cu NPs, fcc-2H-fcc Au—Cu JNS, fcc-2H-fcc Au—Cu CHS, fcc-2H-fcc Au—Cu CSN, or Au+Cu mixture, while such phrase refers 100 μg of Au when the sample is pure fcc-2H-fcc Au NRs. The obtained precipitate was redispersed into 96 μL of ethanol, followed by the addition of 4 μL of Nafion solution (5 wt %) and subsequent sonication for 5 mins to make a homogeneous catalyst ink. Then 30 μL of catalyst ink were dropped onto the glassy carbon electrode (GCE) with a diameter of 5 mm, which contains 30 μg of Cu. Note that for the test of fcc-2H-fcc Au NRs, the loading amount of Au was 30 μg per electrode as well. After the electrode was dried, the as-prepared working electrode was kept in vacuum oven before the electrocatalytic test.

### CO₂RR Test in H-Type Cell

All the electrochemical measurements were conducted in a three-electrode system by an Ivium-n-Stat electrochemical workstation. The catalysts were tested in a gas tight two-chamber H-type cell separated by ion exchange membrane (Nafion 212). The CO₂-saturated 0.1 M KHCO₃ aqueous solution was used as the electrolyte. Typically, both anode and cathode chambers were filled with 8 mL of the electrolyte. The catalyst-modified GCE, an Ag/AgCl electrode (filled with saturated KCl solution), and a Pt plate were applied as the working electrode, reference electrode, and counter electrode, respectively. The applied potentials were converted to RHE scale based on the equation of E (vs RHE)=E (vs Ag/AgCl)+0.197+0.0591×pH. All the applied potentials in this work were recorded with 85% solution resistance correction unless otherwise specified.

Before the test, the CO₂ gas (99.999%, Specialty Gas Engineering Company Limited) was purged into the 0.1 M KHCO₃ aqueous solution in the cathode chamber for 30 mins. During the test, the CO₂ gas was kept purging into the 0.1 M KHCO₃ aqueous solution in the cathode chamber with a flow rate of 20 standard cubic centimeter per minute (sccm). The gas products of CO₂RR were analyzed by directly connecting the gas outlet of the cathode chamber to an on-line gas chromatography (GC, Agilent Technologies 7890B), which was equipped with two flame ionization detectors (FIDs) and a thermal conductivity detector (TCD). After CO₂ electrolysis for 1 h, the liquid products in the cathode electrolyte were collected and analyzed by 1H nuclear magnetic resonance (NMR, Bruker AVANCE III HD, 300 MHz) spectrometer.

### Electrochemical CO₂RR Measurement in Flow Cell

### Preparation of the Working Electrode

Typically, 3 mg of catalysts were added into 1 mL of ethanol, followed by the addition of 25 μL of Nafion solution (5 wt %) and subsequent sonication for 5 mins to form a homogenous catalyst ink. After that, 0.83 mL of catalyst ink was dropped onto a gas diffusion electrode (GDE; size: 1.0 cm×2.5 cm, Sigracet 29BC) to ensure the catalyst loading amount is 1.0 mg cm⁻². After the catalyst-modified GDE was naturally dried, it was stored in vacuum oven for further use.

### CO₂RR Test in Flow Cell

The electrochemical CO₂RR measurement was performed in a three-channel flow cell composed of anode chamber, cathode chamber, and CO₂ gas flow field. An anion exchange membrane (Fumasep, FAA-3-PK-130) was used to separate the anode chamber and cathode chamber. The catalyst-modified GDE, saturated Ag/AgCl, and Ni foam was used as working electrode, reference electrode, and counter electrode, respectively. The 1.0 M KOH solution was used as both anolyte and catholyte. The electrolyte in cathode and anode chambers were independently circulated by a two-channel peristaltic pump (LongerPump, BT100-2J) with a flow rate of 10 mL min⁻¹. The high-purity CO₂ gas (99.999%, Specialty Gas Engineering Company Limited) was continuously passed through the CO₂ flow field which is behind the GDE with a flow rate of 5 sccm. The gas products and liquid products were analyzed by the on-line GC and 1H NMR spectrometer, respectively. Note that in order to accurately reflect the applied potentials between the reference electrode and the working electrode in flow cells, no solution resistance correction (IR correction) was made.

### In-situ ATR-FTIR Characterization

The in-situ ATR-FTIR measurement was performed in the absorption mode on a Nicolet iS50 IR spectrometer equipped with a mercury-cadmium-telluride (MCT) detector cooled by liquid nitrogen. The Au-coated Si hemispherical prism (20 mm in diameter, MTI Corporation) loaded with catalysts was used as the working electrode. The ATR-FTIR spectra were collected at a resolution of 8 cm⁻¹. The scan rate is 5 mV s⁻¹ with an expose time of 10 s per spectrum. All spectra were subtracted with the background.

### In-situ DEMS Characterization

In-situ DEMS measurement was conducted on a Linglu DEMS system. The signal was collected during linearly sweeping the working electrode from 0 to −1.3 V (vs RHE) at a scanning rate of 5 mV s⁻¹ in the CO₂-saturated 0.1 M KHCO₃ solution. A home-made electrochemical cell was used for the experiments. The catalyst-modified GCE, Pt wire and saturated Ag/AgCl were used as the working electrode, counter electrode and reference electrode, respectively.

### Calculation Setup

All the theoretical calculations have been performed through the density functional theory (DFT) embedded in the CASTEP packages to reveal the influences of 2H phases. In particular, generalized gradient approximation (GGA) and Perdew-Burke-Ernzerhof (PBE) were applied to guarantee an accurate description of the exchange-correlation interactions in electrocatalysis. Through the selection of ultrafine quality with the ultrasoft pseudopotentials, the plane-wave basis cutoff energy has been set to 440 eV. Meanwhile, we have adopted the K-point set with coarse quality with the Broyden-Fletcher-Goldfarb-Shannon (BFGS) algorithm for all the energy minimizations through the balance of accuracy and efficiency. We have introduced 20 Å in the c-axis to guarantee geometry optimizations with sufficient spaces between periodic cells. For all the geometry optimizations, we have applied stringent criteria, where the Hellmann-Feynman forces should not exceed 0.001 eV/A, and the total energy difference should not be over 5×10⁻⁵ eV/atom.

### Example 1

### Synthesis of fcc-2H-fcc Au NRs

The fcc-2H-fcc Au NRs were synthesized as follows: DDA and OAM were first melted by placing in an oven at 63° C. for 30 mins. Then 2.4 mL of DDA and 1.6 mL of OAM were added into a 20 mL glass vial and successively vortexed for 5 mins to form a homogeneous solution. After that, 6 mg of KAuCl₄ were added into the above solution, followed by purging with oxygen gas for 15 mins. Subsequently, the glass vial was immediately sealed. After sonicating for around 5 mins to form a homogeneous solution, the glass vial was put in an oil bath at 63° C. for 18 h. After the reaction, 4 mL of cyclohexane were added into the glass vial. The resultant mixture was sonicated for 3 mins and then centrifugated at 5,000 rpm for 6 mins to get the products. Finally, the products were further washed with 6 mL of cyclohexane for five times and then re-dispersed into 2 mL of cyclohexane for further use.

### Example 2

### Synthesis of Heterophase fcc-2H-fcc Au—Cu Janus Nanostructures (fcc-2H-fcc Au—Cu JNSs)

To synthesize the fcc-2H-fcc Au—Cu JNS, 2 mL of the fcc-2H-fcc Au NR solution were first centrifuged, and the supernatant was discarded with only the precipitation left. Then 200 μL of OAM/DDA mixture (v/v=2/3) were added into the centrifugation tube containing the Au NR precipitation, followed by sonication for 5 mins to form a homogeneous solution. Subsequently, 1.1 mL of HDO were added into the above solution and then sonicated for 5 mins again. After that, the resultant solution was transferred into a 4 mL glass vial and placed in an oil bath at 120° C. under magnetic stirring, followed by immediately injecting 0.25 mL of Cu(acac)₂ solution (13.20 mM in OAM) at an injection speed of 0.094 mL min⁻¹ with a syringe pump (New Era Pump Systems Inc.). After finishing the injection, the resultant solution was heated for more 2 mins, and then was quickly cooled down to room temperature with an ice bath. To collect the products, the resultant solution was first mixed with 4 mL of n-hexane and centrifuged at 10,000 rpm for 3 mins. Then the obtained precipitation was further washed two times with n-hexane. Finally, the products were redispersed into 1 mL of n-hexane and stored in a refrigerator for further use.

### Example 3

### Synthesis of Heterophase fcc-2H-fcc Au—Cu Co-axial Heteronanostructures (fcc-2H-fcc Au—Cu CAHs)

To synthesize the fcc-2H-fcc Au—Cu CAH, 2 mL of the fcc-2H-fcc Au NR solution were first centrifuged, and the supernatant was discarded with only the precipitation left. Then 200 μL of OAM/DDA mixture (v/v=2/3) were added into the centrifugation tube containing the Au NR precipitation, followed by sonication for 5 mins to form a homogeneous solution. After transferring the above solution into a 4 mL glass vial, 1.3 mL of HDD (pre-melted in an oven) were added and sonicated for 5 mins again. Then the resultant solution was placed in an oil bath at 120° C. under magnetic stirring, followed by immediately injecting 0.5 mL of Cu(acac)₂ solution (4.80 mM in OAM) at an injection speed of 0.062 mL min⁻¹ using a syringe pump. After finishing the injection, the resultant solution was heated for 10 mins, and then quickly cooled down to room temperature with an ice bath. To collect the products, the resultant solution was first mixed with 4 mL of hot n-hexane and centrifuged at 10,000 rpm for 3 mins. Then the obtained precipitation was further washed two times with hot n-hexane. Finally, the products were redispersed into 1 mL of n-hexane and stored in a refrigerator for further use.

### Example 4

### Synthesis of Heterophase fcc-2H-fcc Au—Cu Core-Shell Nanostructures (fcc-2H-fcc Au—Cu CSNs)

To synthesize the fcc-2H-fcc Au—Cu CSN, 2 mL of the fcc-2H-fcc Au NR solution were first centrifuged, and the supernatant was discarded with only the precipitation left. Then 200 μL of OAM/DDA mixture (v/v=2/3) were added into the centrifugation tube containing the Au NR precipitation, followed by sonication for 5 mins to form a homogeneous solution. Subsequently, 800 μL of HDO were added and sonicated for 5 mins again. After transferring the resultant solution into a 4 mL glass vial and successively adding 0.75 mL of Cu(acac)₂ solution (8.00 mM in OAM) in one-batch by a pipette, it was immediately placed in an oil bath at 160° C. and heated for 15 mins under magnetic stirring. To collect the products, the resultant solution was first mixed with 4 mL of n-hexane and centrifuged at 10,000 rpm for 3 mins. Then the obtained precipitation was further washed two times with n-hexane. Finally, the products were redispersed into 1 mL of n-hexane and stored in a refrigerator for further use.

### Example 5

### Synthesis and Structural Characterization of the Heterophase fcc-2H-fcc Au—Cu Heteronanostructures

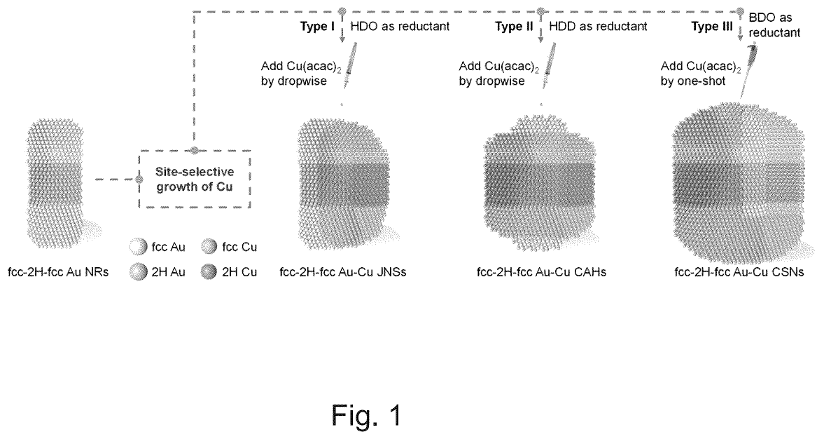

As schematically shown in FIG. 1, the site-selective epitaxial growth of heterophase fcc-2H-fcc Cu was conducted by using the well-defined heterophase fcc-2H-fcc Au NRs as seeds, and precisely tuning the reduction kinetics and the concentration of copper acetylacetonate (Cu(acac)₂), as well as selecting suitable surfactants. In particular, the reduction kinetics of Cu precursors was systematically controlled by choosing appropriate reductants, together with suitable injection speeds of Cu precursors.

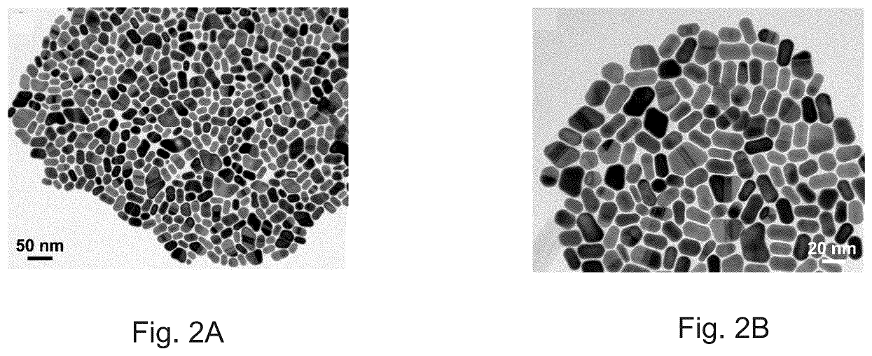

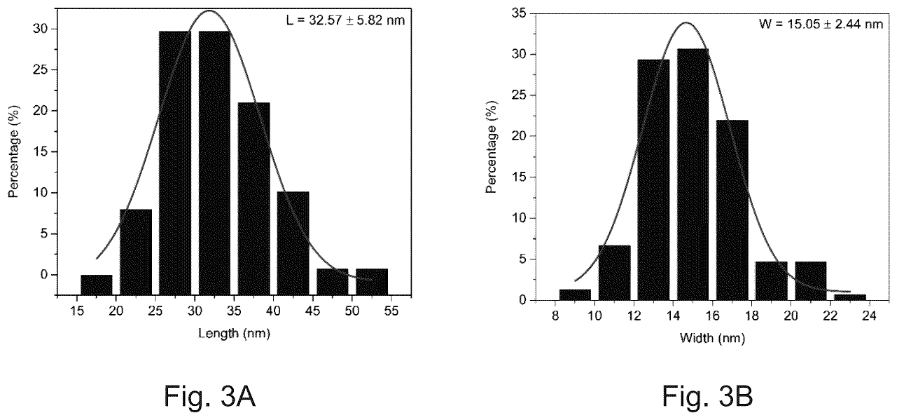

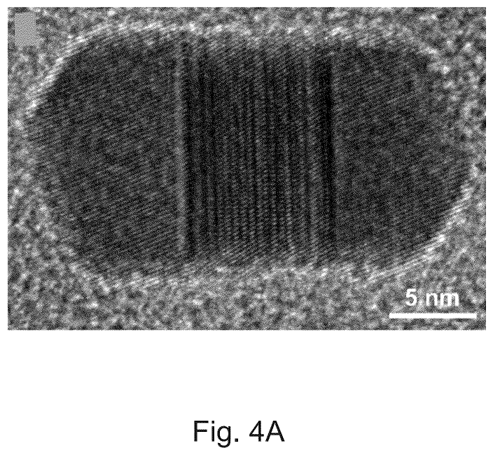

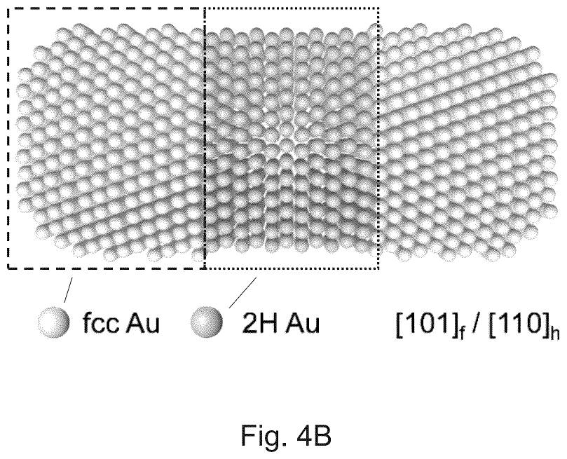

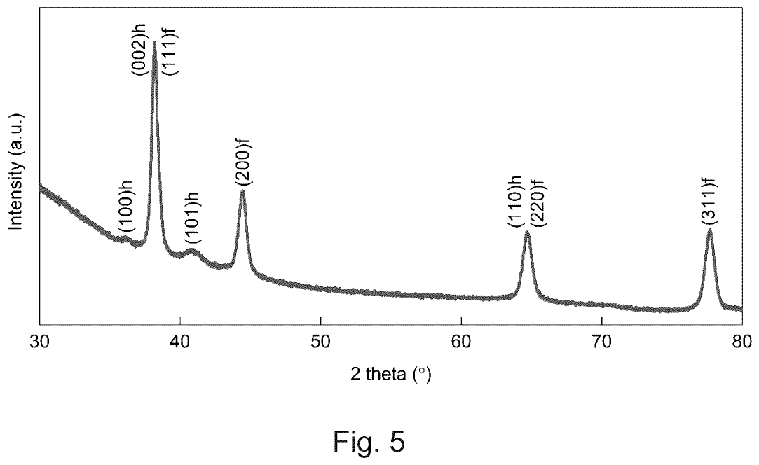

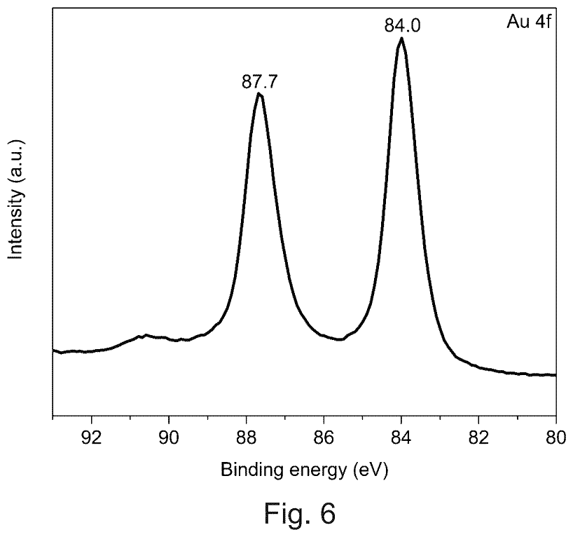

Specifically, the heterophase fcc-2H-fcc Au NRs were synthesized by reducing KAuCl₄ in the solvent of OAM/DDA mixture (v/v=2/3) at 63° C. for 18 h. TEM images indicate the as-prepared Au NRs show a rod-like morphology with high purity (FIGS. 2A and 2B). The statistical analysis of Au NRs suggests that the heterophase fcc-2H-fcc Au NRs possess a length of 32.57+5.82 nm and a width of 15.05+2.44 nm (FIGS. 3A and 3B). The HRTEM image confirms that the two ends and middle area of Au NRs demonstrate fcc phase and 2H phase, respectively, forming a well-defined fcc-2H-fcc heterophase along the long axis (FIG. 4A). A crystal model exhibiting the phase distribution in the as-prepared Au NRs is schematically presented in FIG. 4B. The XRD pattern further confirms the fcc-2H-fcc heterophase of Au NRs (FIG. 5). The XPS spectrum of the Au 4f doublet indicates the metallic state of Au in these as-prepared Au NRs (FIG. 6)

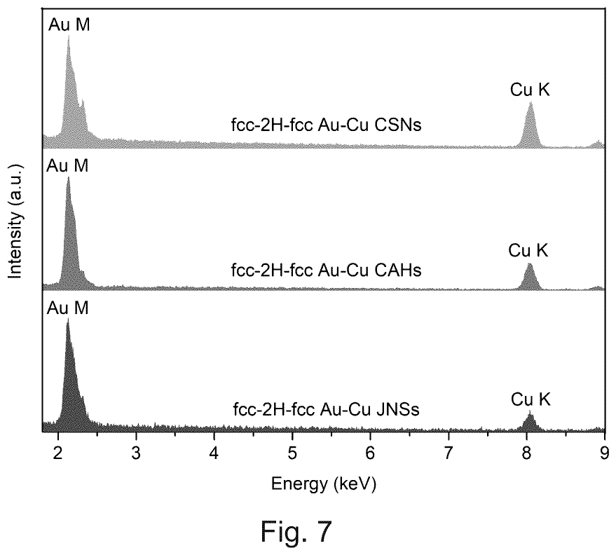

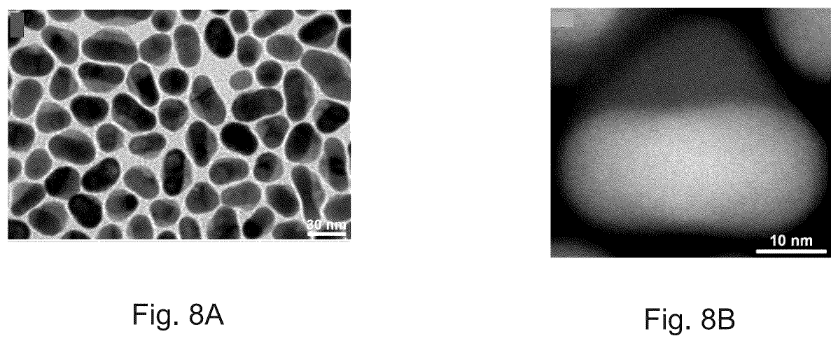

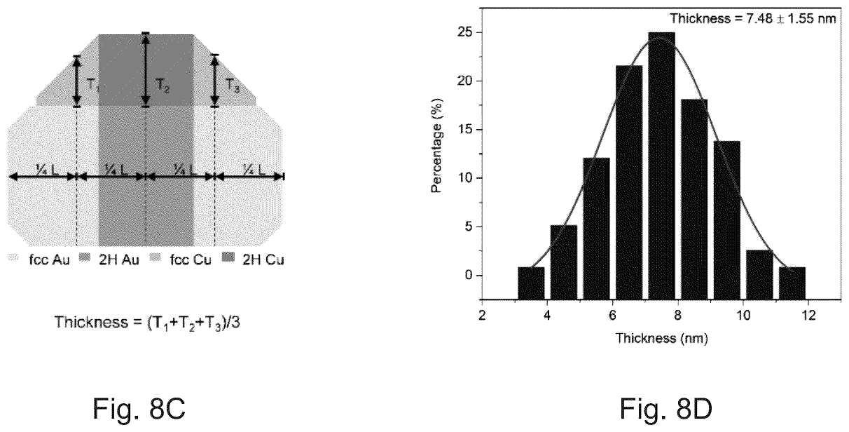

For fcc-2H-fcc Au—Cu JNSs, they were synthesized by choosing 1,2-hexanediol (HDO) as the reductant and injecting Cu(acac)₂ solution with a syringe pump at 0.094 mL min⁻¹ (FIGS. 1 and 7). The transmission electron microscopy (TEM) and high-angle annular dark-field scanning TEM (HAADF-STEM) images of fcc-2H-fcc Au—Cu JNSs reveal the segregated distribution of Cu domain and Au domain within individual nanostructures, and the thickness of Cu domains is around 7.48+1.55 nm (FIGS. 8A to 8D).

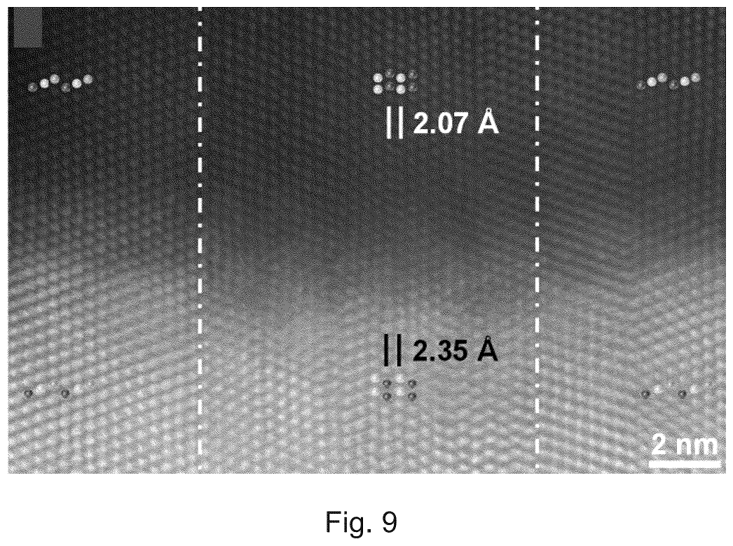

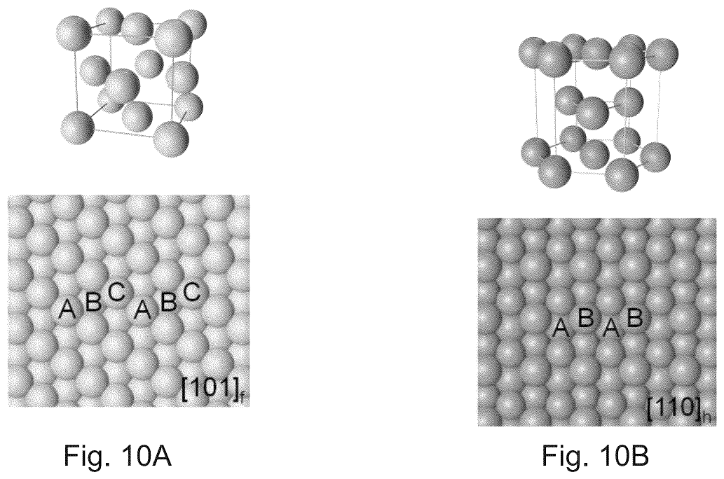

A representative spherical aberration-corrected HAADF-STEM image in FIG. 9 probes the structure of fcc-2H-fcc Au—Cu JNSs at atomic scale, indicating the epitaxial growth of Cu domain on the fcc-2H-fcc Au NRs. The measured lattice spacings of 2.07 Å and 2.35 Å are consistent with the interplanar distances of closed-packed planes of Cu and Au, respectively. Importantly, the middle area of Cu domain presents “AB” staking sequence along the close-packed direction, while the two ends show a characteristic stacking sequence of “ABC”, suggesting the fcc-2H-fcc heterophase of Cu domains. Similar structural features are also observed in the Au domains.

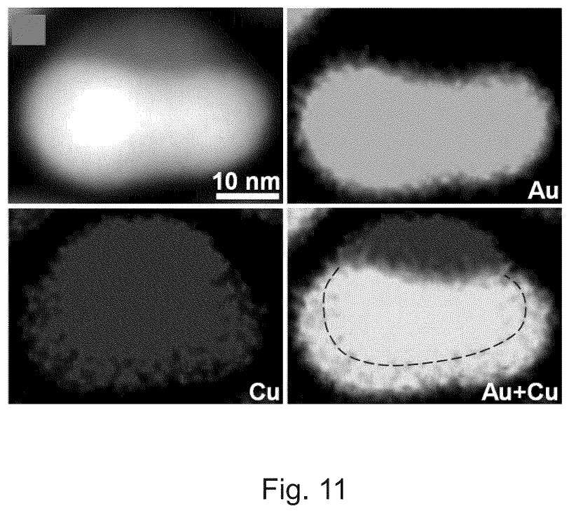

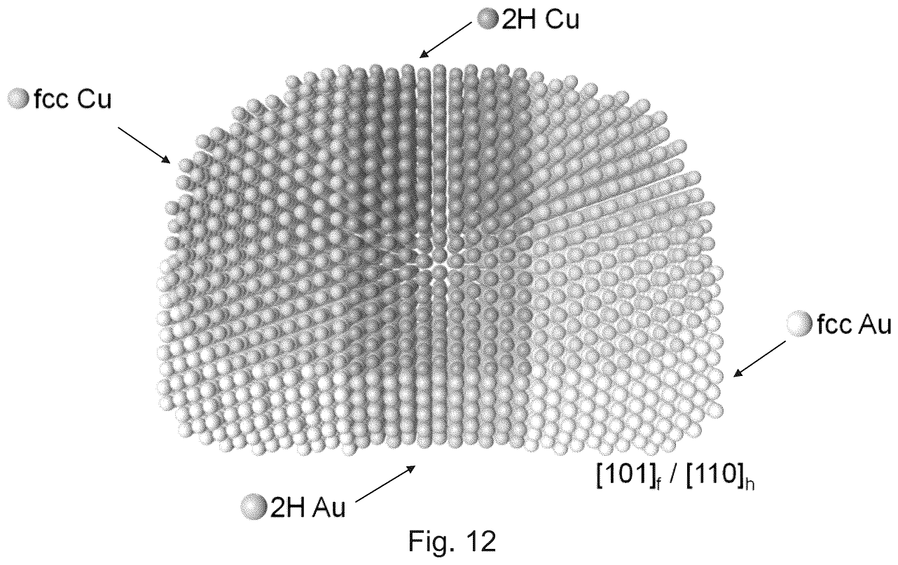

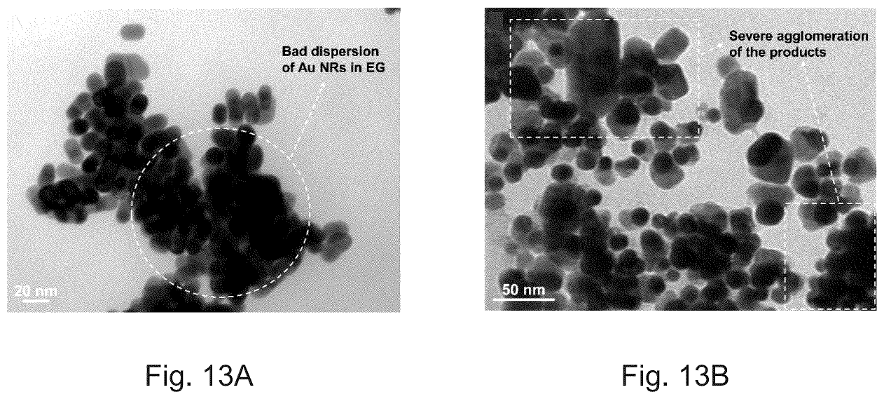

To further illustrate the phase distribution of Cu domains, fcc phase and 2H phase are schematically illustrated in FIGS. 11A and 11B, where the characteristic stacking sequences of the close-packed planes, i.e., “ABC” for fcc phase and “AB” for 2H phase, are well presented. The HAADF-STEM image and corresponding energy-dispersive X-ray spectroscopy (EDS) elemental mappings indicate that Cu is deposited on one side of Au NRs, leaving the other areas of Au NRs exposed (FIG. 12). The HAADF-STEM tomographic reconstruction further confirms the asymmetric Au—Cu heteronanostructures. Based on the aforementioned characterizations, a crystal model exhibiting an Au—Cu JNS with the co-exposure of both fcc-2H-fcc Au and fcc-2H-fcc Cu is schematically shown in FIG. 13.

It is believed that the well dispersion of Au NRs, appropriate injection speed of Cu precursor, and suitable Cu(acac)₂ concentration are all critical to the successful synthesis of fcc-2H-fcc Au—Cu JNSs.

It is also believed that the well dispersion of fcc-2H-fcc Au NRs by choosing suitable solvents is highly important for the successful synthesis of fcc-2H-fcc Au—Cu JNSs. As shown in the FIG. 13A, if the polar solvent like EG was used, the fcc-2H-fcc Au NRs cannot be well dispersed, leading to formation of large agglomeration of fcc-2H-fcc Au NRs. As a result, although some fcc-2H-fcc Au—Cu JNSs can be observed, the severe agglomeration always exits in the final products (FIG. 13B).

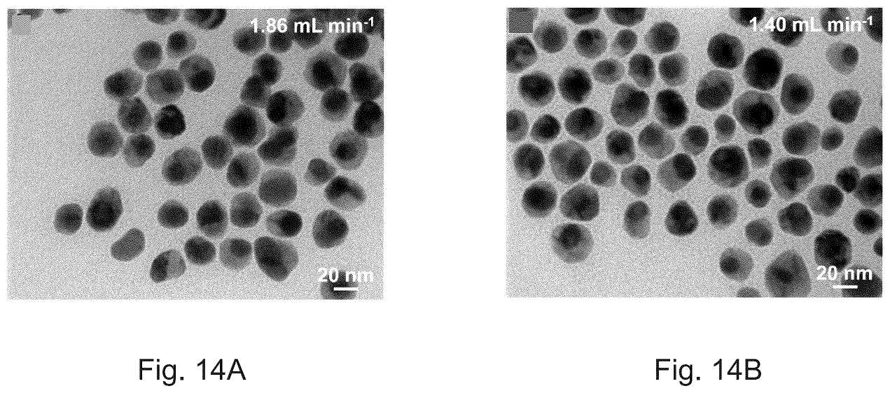

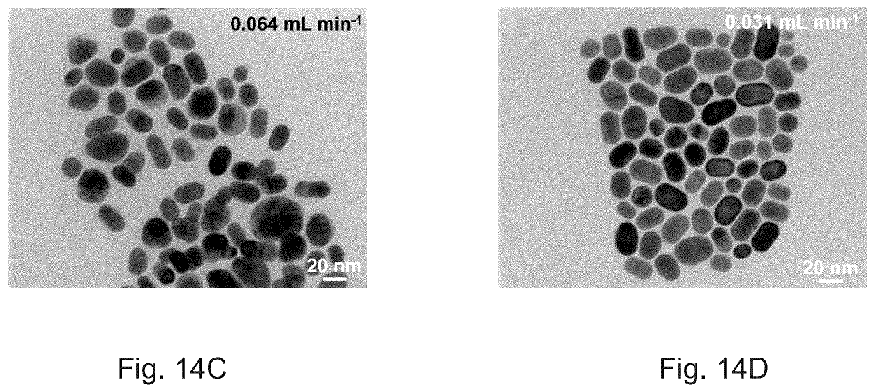

It is further believed that the effect of injection speed would affect the reduction kinetics for synthesizing fcc-2H-fcc Au—Cu JNSs. To study as such, the injection speed was systematically tuned from 0.094 mL min-1 to 1.86 mL min-1, 1.40 mL min-1, 0.064 mL min-1 and 0.031 mL min⁻¹, respectively. When the injection speed is too high, most of the Cu domains fully cover the fcc-2H-fcc Au NRs (FIG. 14A). When the injection speed gradually decreases, the content of fcc-2H-fcc Au—Cu JNSs gradually increases (FIGS. 14B and 14C). However, when the injection speed is too low, the Cu precursors are hard to be reduced. The above results suggest that a suitable injection speed is important for the successful synthesis of fcc-2H-fcc Au—Cu JNSs (FIG. 14D)

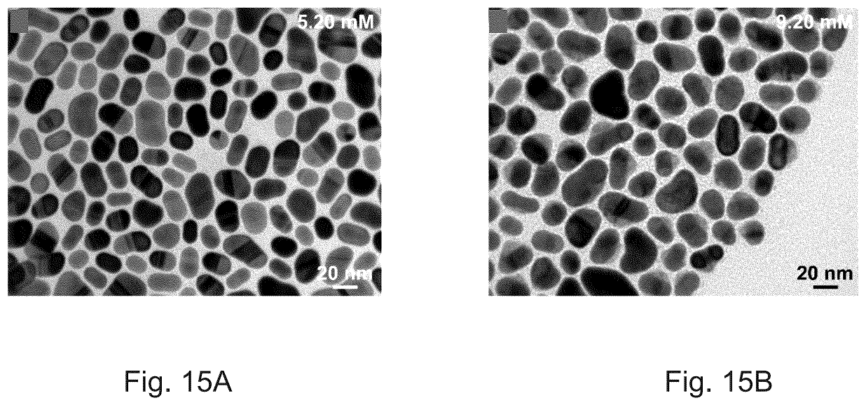

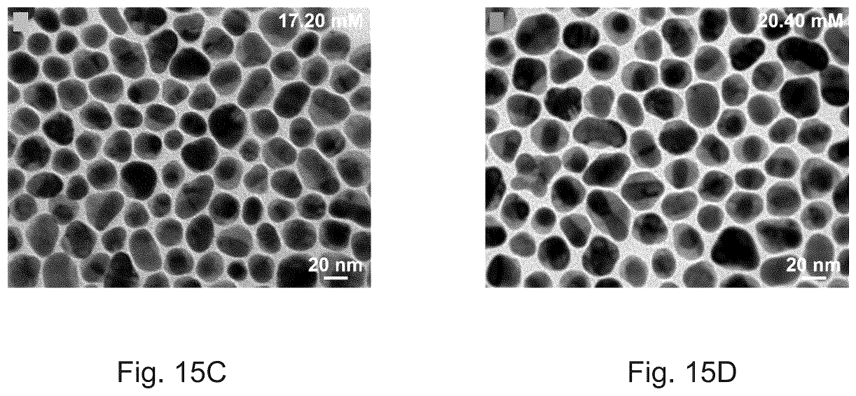

Besides, it is believed that the concentration of Cu precursors would affect the synthesis of fcc-2H-fcc Au—Cu JNSs as well. Thus, the effect of the concentration of Cu precursors was studied by changing the Cu precursor concentration from 13.20 mM to 5.20 mM, 9.20 mM, 7.20 mM and 20.40 mM, respectively. When the concentration of Cu precursors is as low as 5.20 mM, the Cu precursors cannot be reduced, and no Cu growth on the fcc-2H-fcc Au NRs (FIG. 15A). When the Cu concentration increases to 9.20 mM, some fcc-2H-fcc Au—Cu JNSs appear (FIG. 15B). However, when the Cu concentration increases up to 17.20 mM and 20.40 mM, respectively, the Cu domains in final products fully cover the Au NRs in most cases (FIGS. 15C and 15D). The above results indicate that the appropriate concentration of Cu precursors is important for the successful synthesis of fcc-2H-fcc Au—Cu JNSs as well.

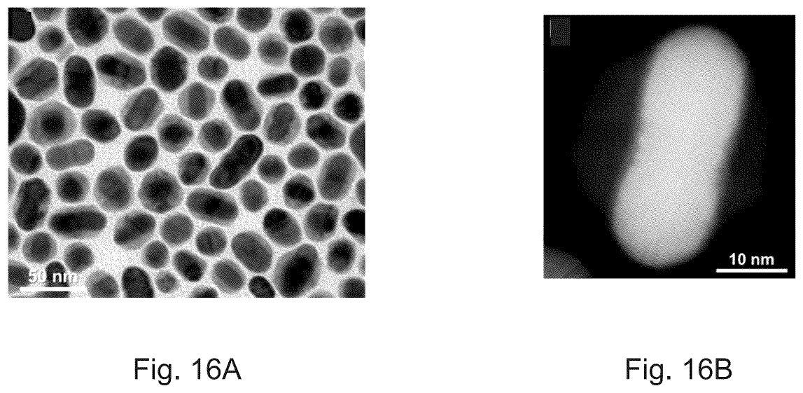

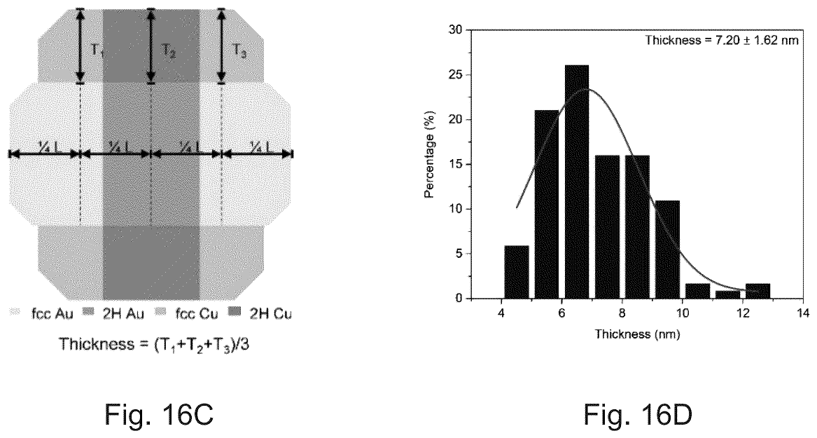

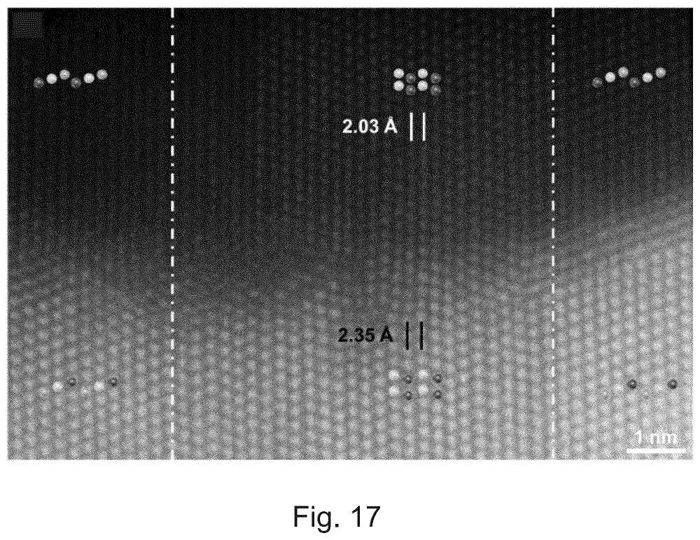

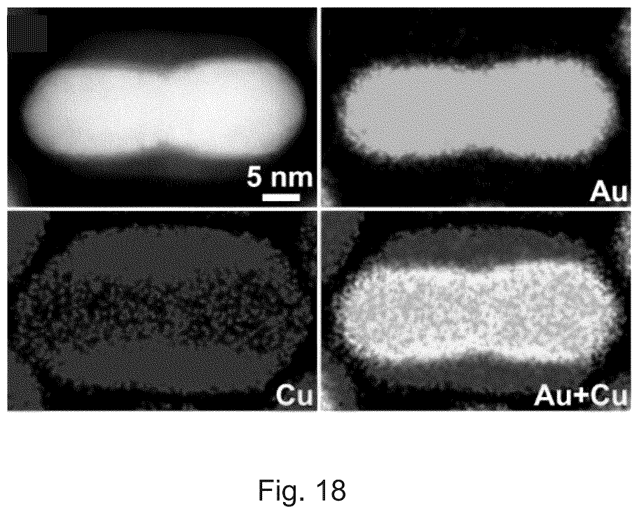

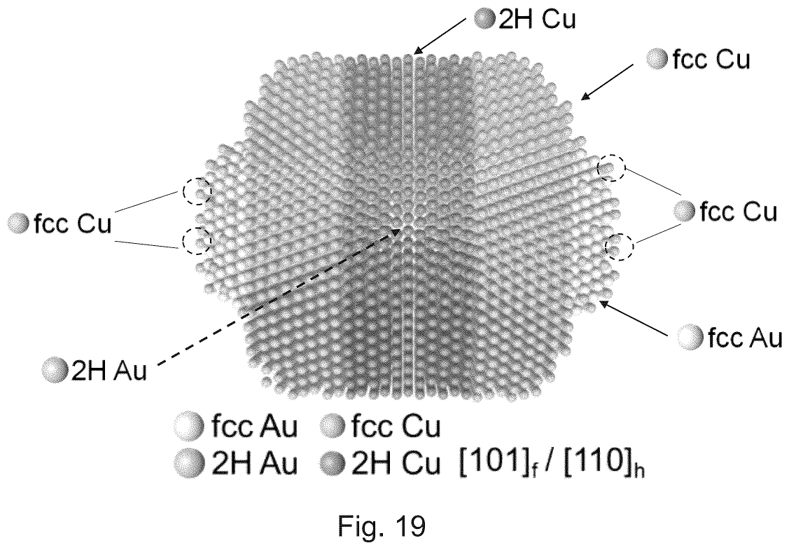

In parallel, fcc-2H-fcc Au—Cu CAHs were synthesized by choosing 1,2-hexadecanediol (HDD) as reductant and injecting Cu(acac)₂ solution via a syringe pump at 0.062 mL min⁻¹ (FIGS. 1 and 7). TEM and STEM images reveal the size distribution and the morphology of fcc-2H-fcc Au—Cu CAHs, where the Cu domain has a thickness of about 7.20+1.62 nm (FIGS. 16A to 16D). FIG. 17 shows a representative spherical aberration-corrected HAADF-STEM image of fcc-2H-fcc Au—Cu CAHs, indicating that the Cu domain epitaxially grows on fcc-2H-fcc Au NRs. Similarly, the Cu domain adopts the fcc-2H-fcc heterophase, verified by the characteristic stacking sequences of “AB” in the middle region and “ABC” in the two ends of Cu domains. Meanwhile, the Au domains also maintain the fcc-2H-fcc heterophase. The measured lattice spacings of 2.03 Å and 2.35 Å agree well with the interplanar distances of closed-packed planes of Cu and Au, respectively. The HAADF-STEM image and corresponding EDS elemental mappings indicate that Cu is mainly deposited on the side of Au NRs but seldomly grown on the two tips of Au NRs, resulting in the selective exposure of Au at the two ends of resultant nanostructures (FIG. 18). On the basis of these observations, FIG. 19 schematically depicts the crystal structure of a typical fcc-2H-fcc Au—Cu CAH.

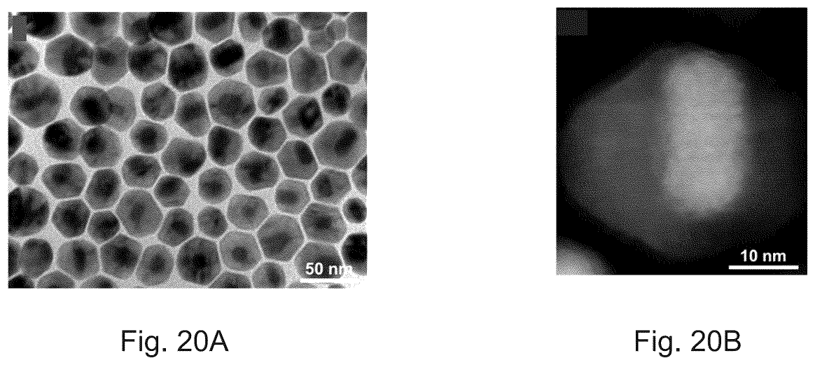

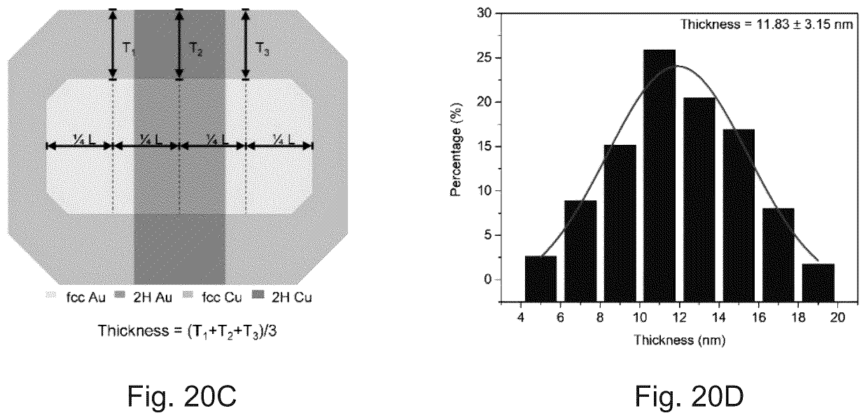

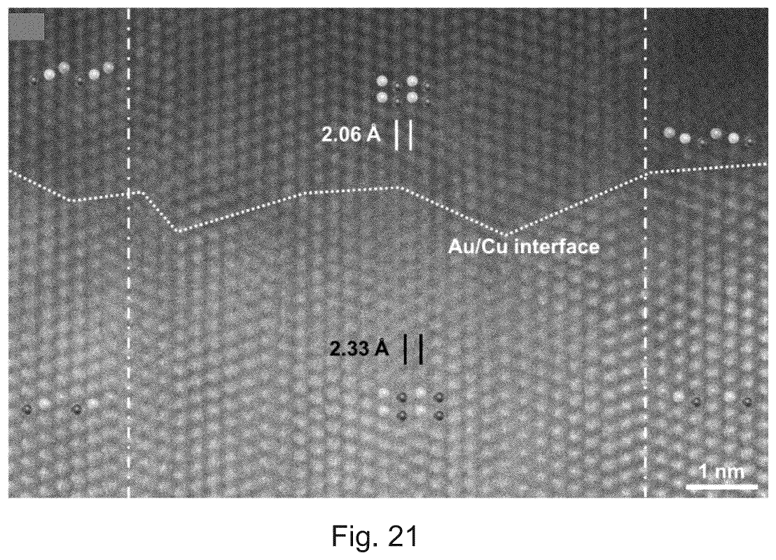

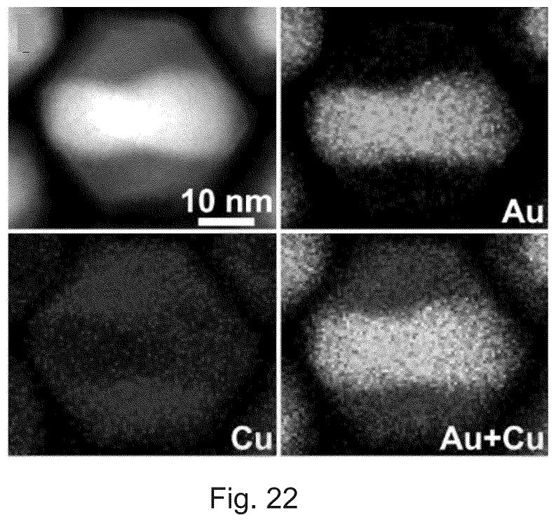

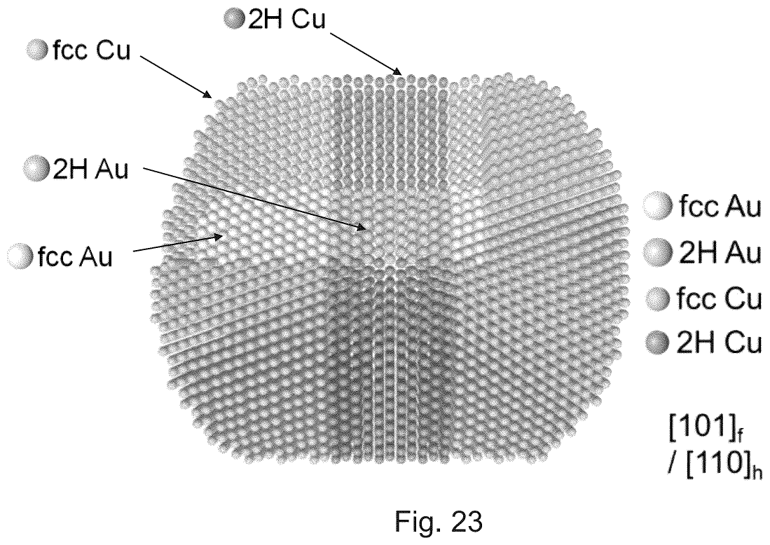

When using 1,2-butanediol (BDO) as reductant and adding Cu(acac)₂ solution in one shot (one-batch) via a pipette, fcc-2H-fcc Au—Cu CSNs were obtained (FIGS. 1 and FIGS. 20A to 20D). A representative spherical aberration-corrected HAADF-STEM image in FIG. 21 displays the epitaxial growth of Cu on Au NRs. The characteristic stacking sequences in the middle area and two ends of Cu domains indicate their fcc-2H-fcc heterophase. The measured lattice spacings of 2.06 Å and 2.33 Å are assigned to the interplanar distances of closed-packed planes of Cu and Au, respectively. The HAADF-STEM image and EDS elemental mappings suggest that the Au core is fully covered by the Cu shell (FIG. 22). Taken together, a crystal model illustrating the fcc-2H-fcc core-shell structure of Au—Cu CSNs is shown in FIG. 23.

### Example 6

### X-ray Spectral Analysis of the Heterophase fcc-2H-fcc Au—Cu Heteronanostructures

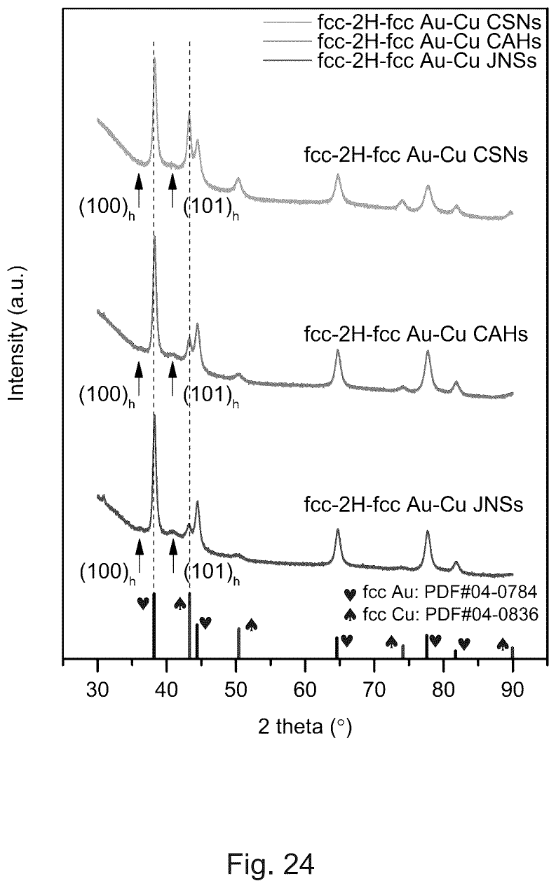

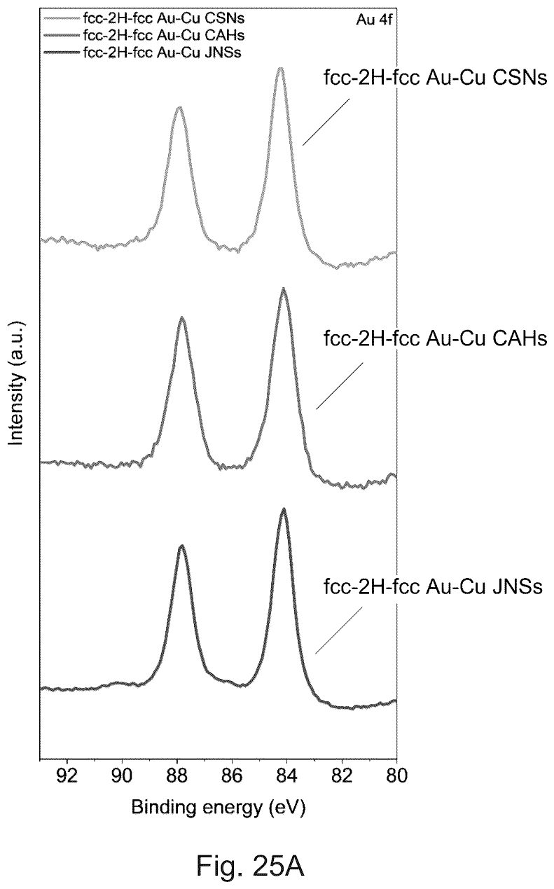

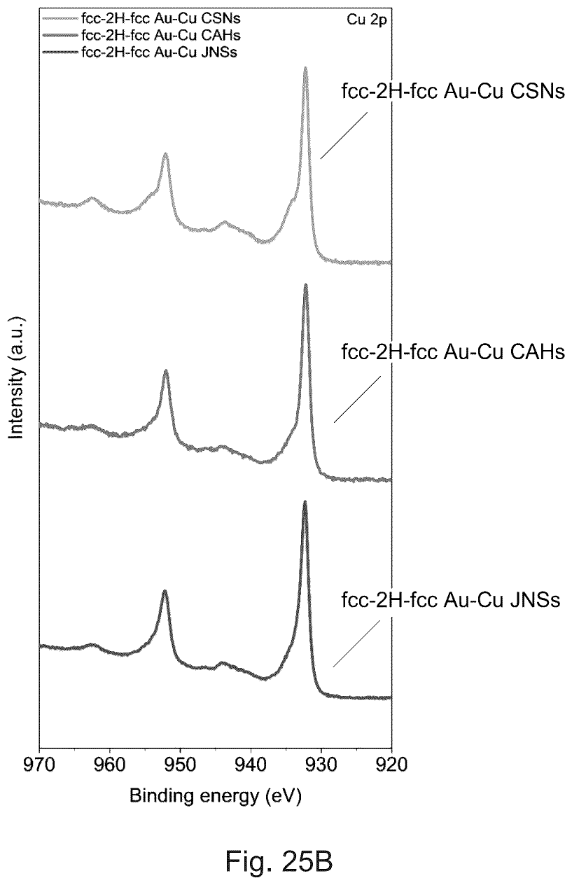

X-ray diffraction (XRD) was used to investigate the structure of as-prepared fcc-2H-fcc Au—Cu heteronanostructures (FIG. 24). After the growth of Cu on Au NRs, the characteristic peaks of 2H Au, i.e., (100)ₕ and (101)ₕ, are well preserved in the XRD pattern. Moreover, the peak positions of Au and Cu do not show obvious shift compared with the standard ones, which indicates the phase segregation of Au and Cu in the resultant heteronanostructures, matching well with the observations by TEM, STEM and EDS. The X-ray photoelectron spectroscopy (XPS) core-level spectra of Au 4f doublet and Cu 2p doublet suggest the metallic states of Au and Cu in these fcc-2H-fcc Au—Cu nanostructures (FIGS. 25A and 25B). Meanwhile, the small satellite peaks in Cu 2p XPS spectra might originate from the slight oxidation of Cu in air.

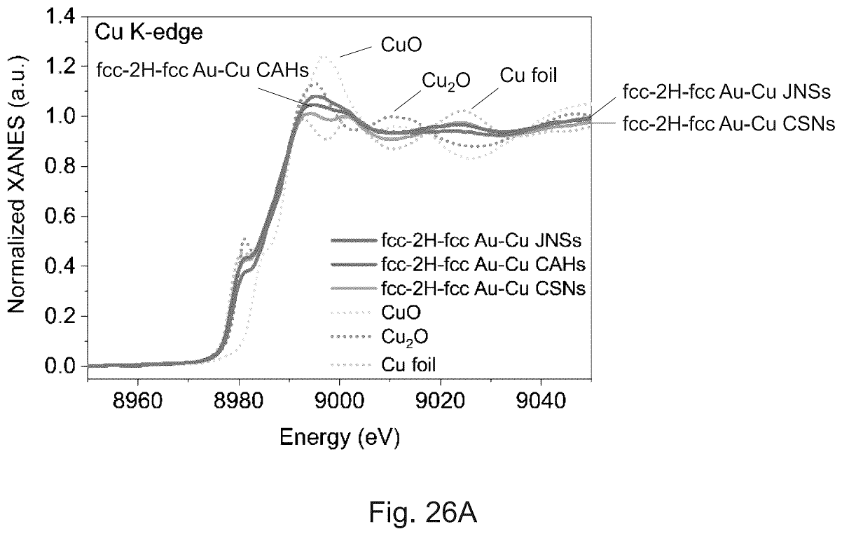

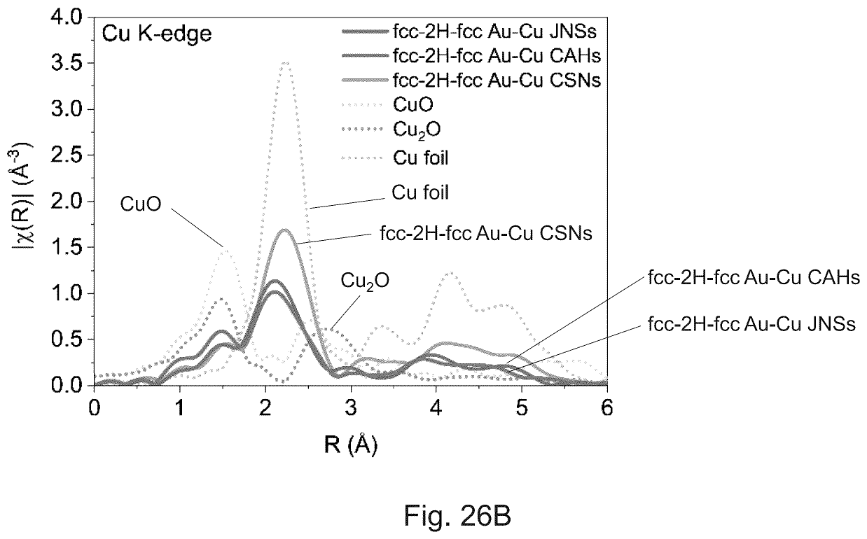

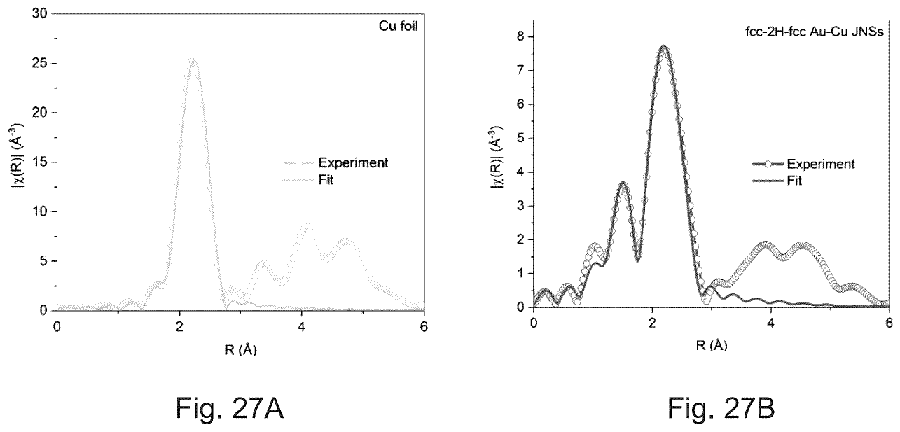

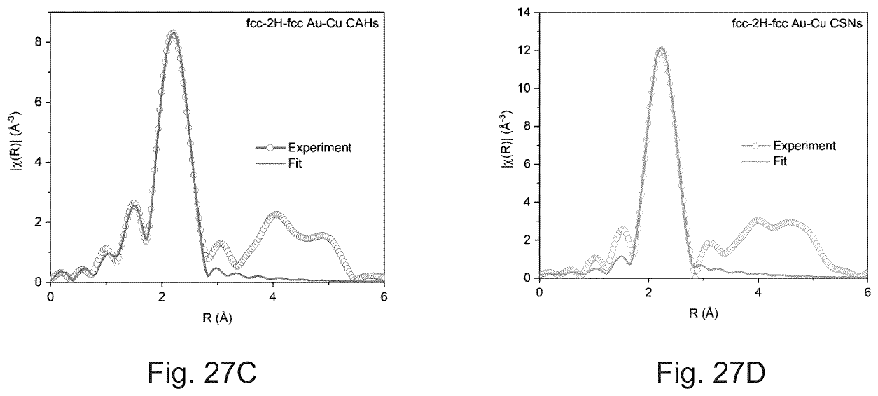

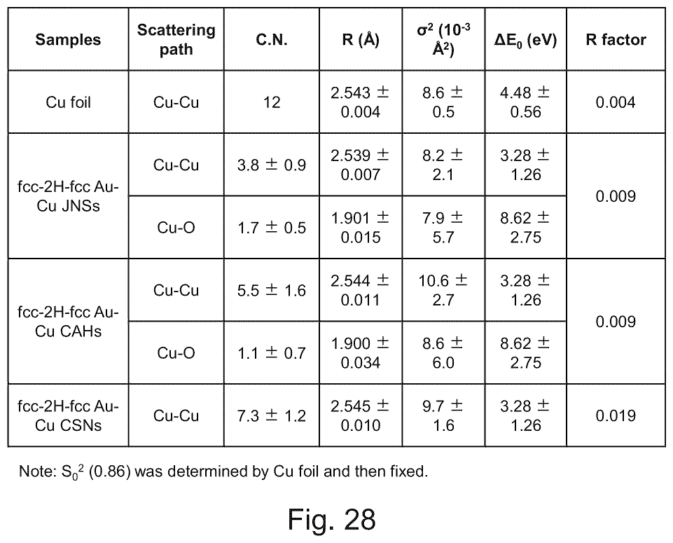

X-ray absorption spectroscopy (XAS) was further utilized to probe the electronic structure and coordination environment of as-prepared fcc-2H-fcc Au—Cu heteronanostructures. In the Cu K-edge X-ray absorption near-edge structure (XANES) spectra, the white line positions of fcc-2H-fcc Au—Cu heteronanostructures locate between the Cu foil and Cu₂O or CuO, and their spectra are more similar to the Cu foil (FIG. 26A), suggesting the Cu domains mainly stay in metallic state but with slight oxidation in the surface Cu atoms. In the Cu K-edge extended X-ray absorption fine structure (EXAFS) spectra, the main peak at around 2.2 Å is ascribed to Cu—Cu scattering path (FIG. 26B). The fitted results of Cu K-edge EXAFS spectra reveal that Cu—Cu bonds in the as-prepared fcc-2H-fcc Au—Cu heteronanostructures and Cu foil have similar bond lengths of ˜2.54 Å (FIGS. 27A to 27D and FIG. 28).

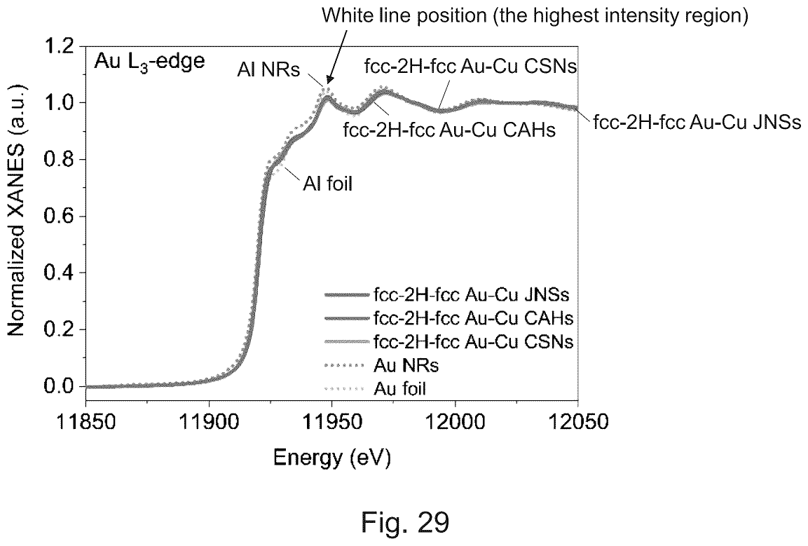

The Cu—Cu coordination numbers of fcc-2H-fcc Au—Cu JNSs, CAHs, and CSNs are different, i.e., 3.8, 5.5, and 7.3, respectively, which largely arises from the variation of Cu domain sizes in these heteronanostructures (FIGS. 8B, 16B and 20B). Simultaneously, the Cu—Cu coordination numbers in as-prepared fcc-2H-fcc Au—Cu heteronanostructures are all much larger than their corresponding Cu—O coordination numbers, further proving that the metallic Cu is the dominant. In the Au L3-edge XANES spectra (FIG. 29), the white line positions of as-prepared fcc-2H-fcc Au—Cu heteronanostructures are similar to Au NRs and Au foil, suggesting Au domains in three samples stay in the metallic state, consistent with the XPS results (FIG. 25A).

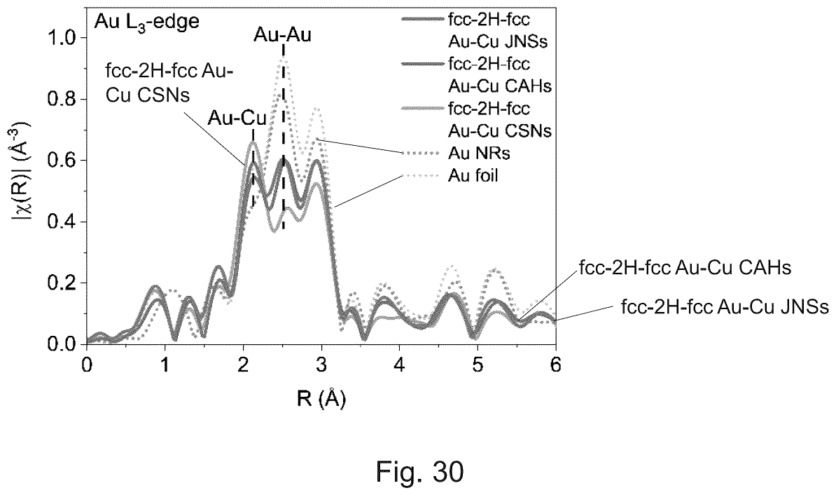

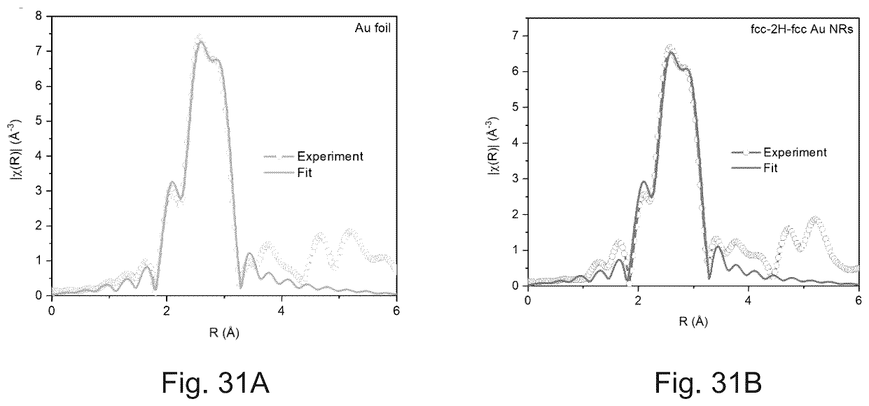

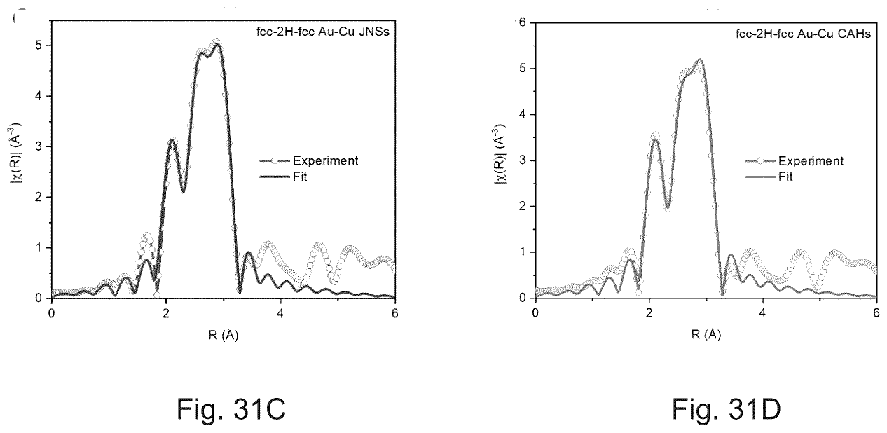

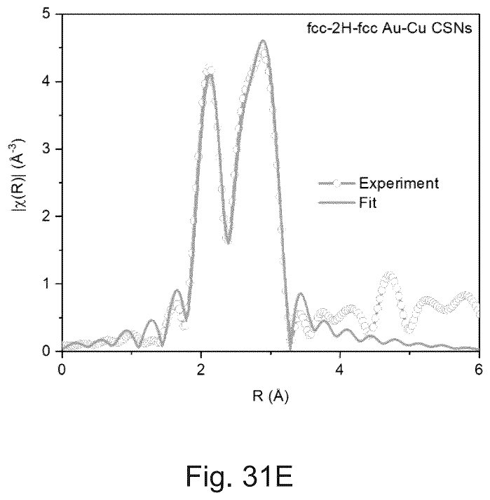

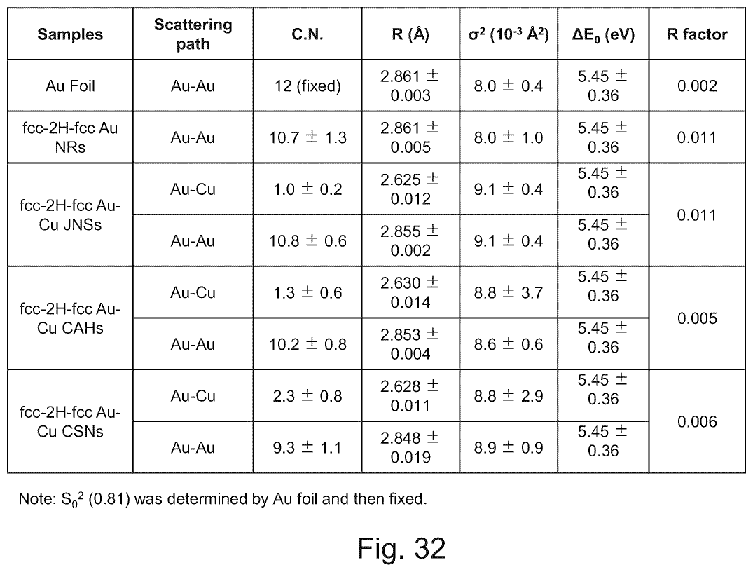

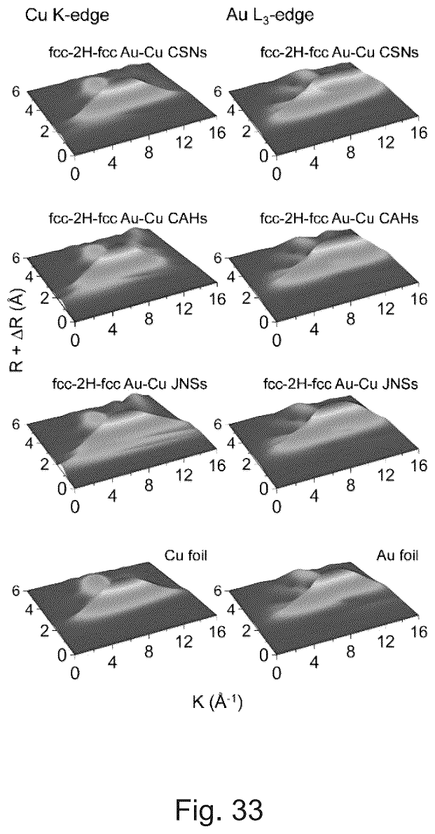

In the Au L3-edge EXAFS spectra (FIG. 30), apart from the Au—Au scattering paths, the Au—Cu scattering paths also appear for the as-prepared fcc-2H-fcc Au—Cu heteronanostructures. Correspondingly, the fitted results of Au L3-edge EXAFS spectra demonstrate the increase of Au—Cu coordination numbers from 1.0 to 1.3 and 2.3 when the samples change from Au—Cu JNSs to Au—Cu CAHs and Au—Cu CSNs (FIGS. 31A to 31E and FIG. 32), suggesting more and more surface Au atoms coordinate with Cu atoms in this order. This observation agrees well with the TEM results (FIGS. 8A, 16A and 20A). The intensity maxima of wavelet transform (WT) of Cu K-edge EXAFS spectra of the as-prepared fcc-2H-fcc Au—Cu heteronanostructures are very close to Cu foil (FIG. 33, left), reconfirming that the metallic Cu are dominant in all three samples. In the Au L3-edge WT, the intensity maximum of Au—Cu JNSs, Au—Cu CAHs and Au—Cu CSNs are also similar to that of Au foil, suggesting the formation of Au—Cu bonds at interface and the metallic state of most Au species (FIG. 33, right).

### Example 7

### Electrochemical CO₂RR Performance of the Heterophase fcc-2H-fcc Au—Cu Heteronanostructures

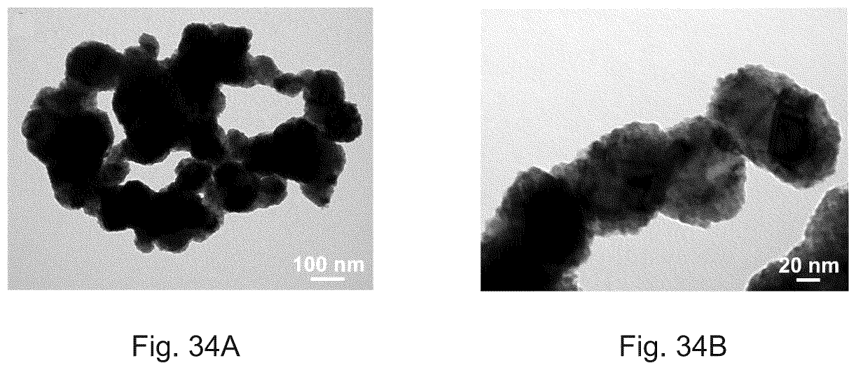

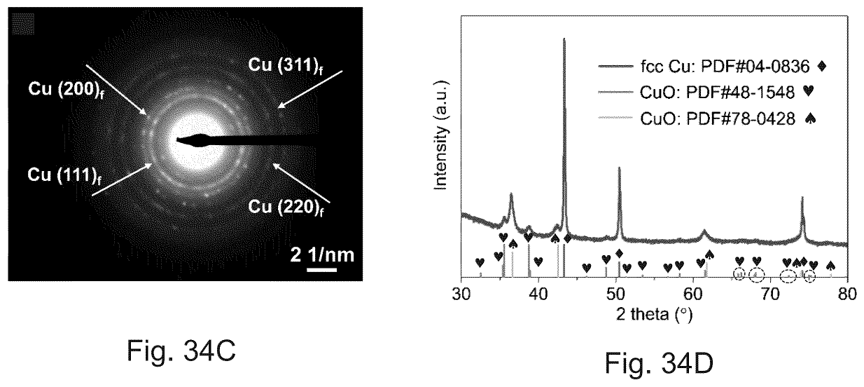

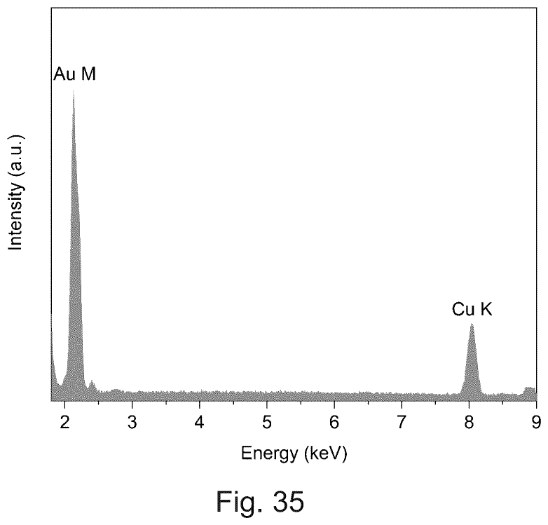

The as-prepared fcc-2H-fcc Au—Cu heteronanostructures were applied as catalysts in the electrochemical CO₂RR. The CO₂-reduction measurements were first performed in the H-type cell by using 0.1 M potassium bicarbonate (KHCO₃) aqueous solution as electrolyte, in which the catalysts modified glass carbon electrode, Ag/AgCl (in saturated KCl solution), and Pt plate were utilized as the working electrode, reference electrode, and counter electrode, respectively. As control samples, fcc-2H-fcc Au NRs, commercial fcc Cu nanoparticles (NPs; FIGS. 34A to 34D), and the physical mixture of fcc-2H-fcc Au NRs and commercial fcc Cu NPs (denoted as Au+Cu mixture; FIG. 35) were also tested under the same conditions.

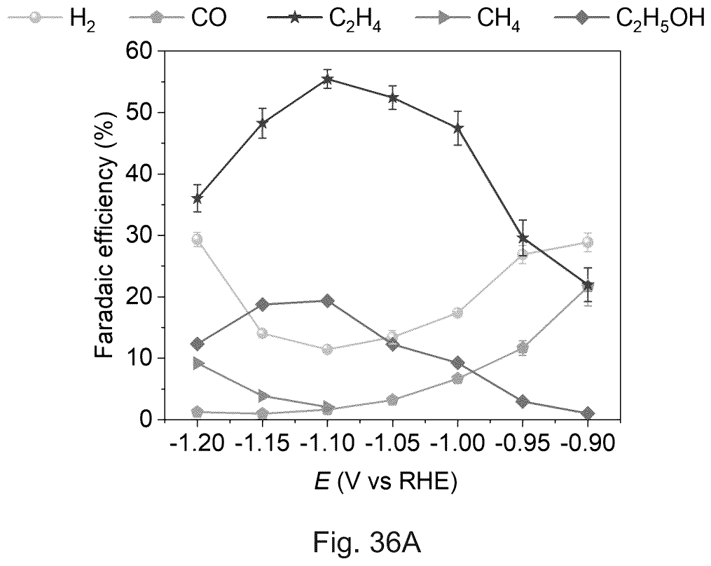

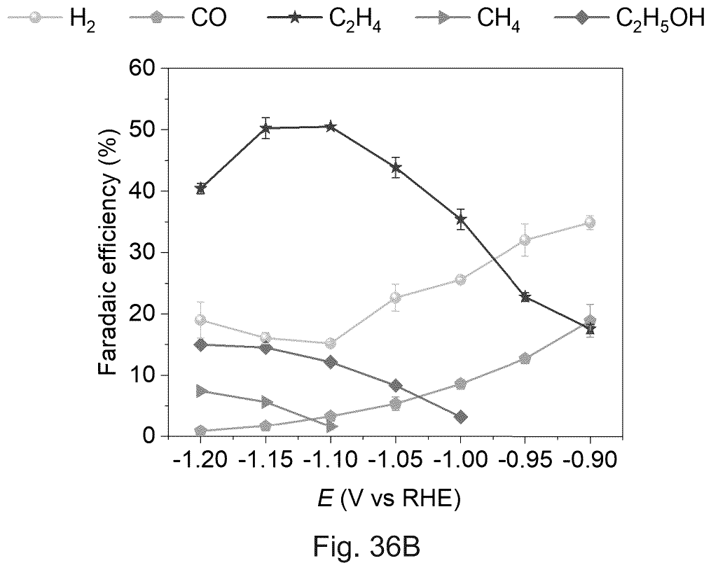

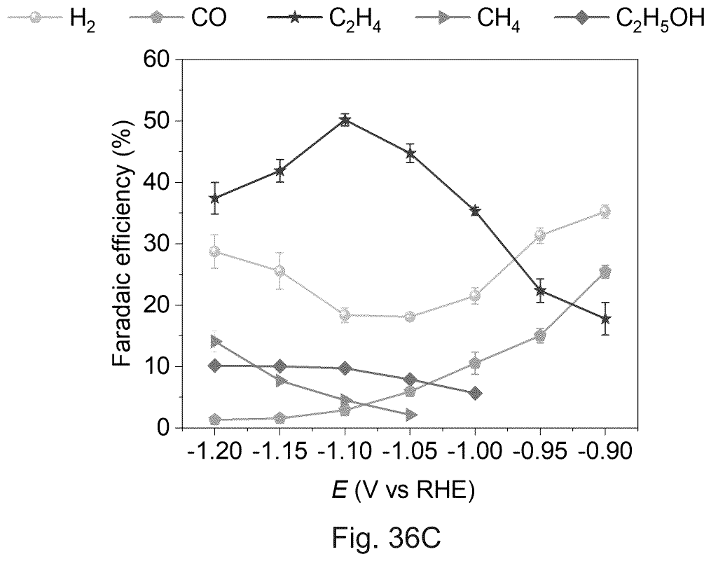

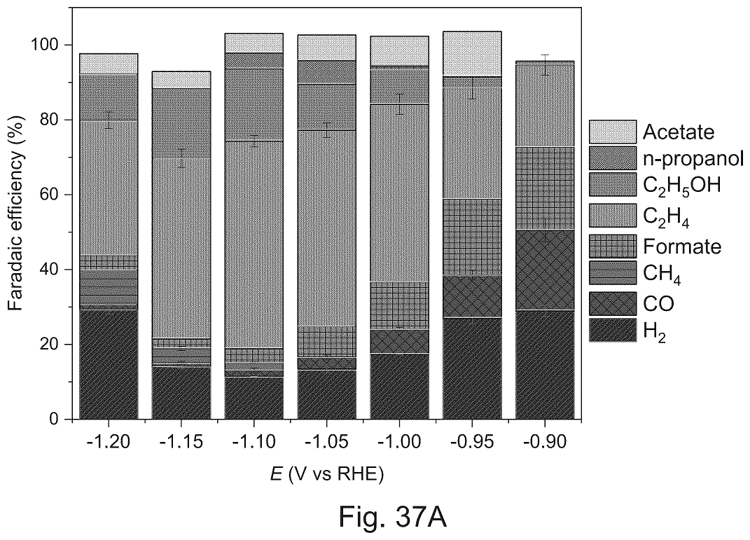

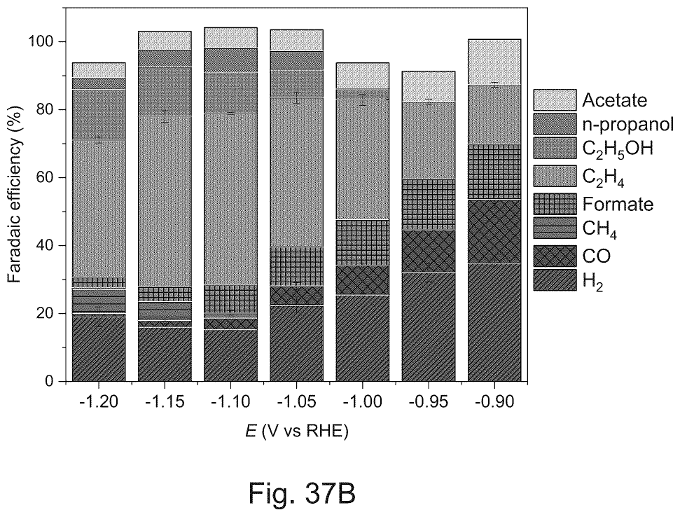

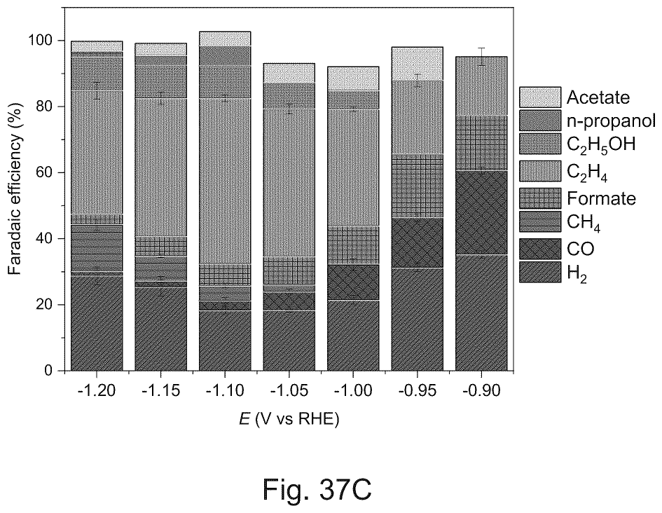

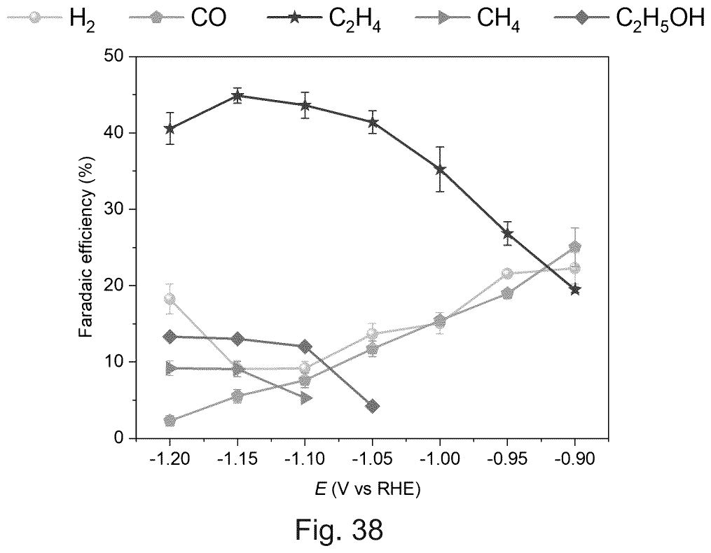

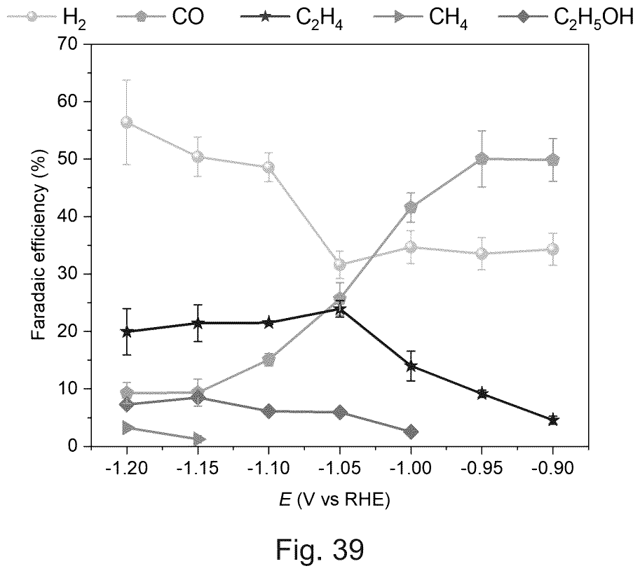

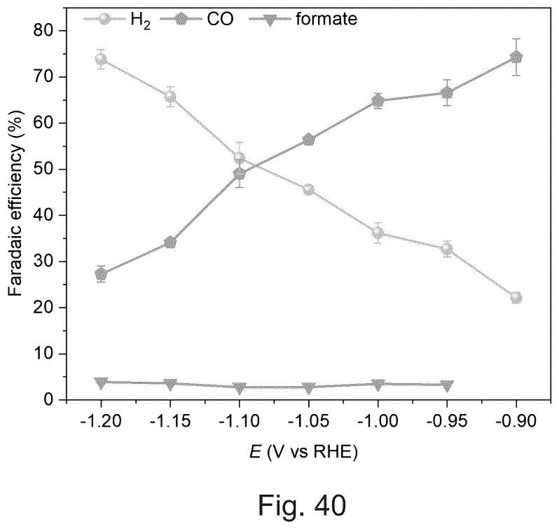

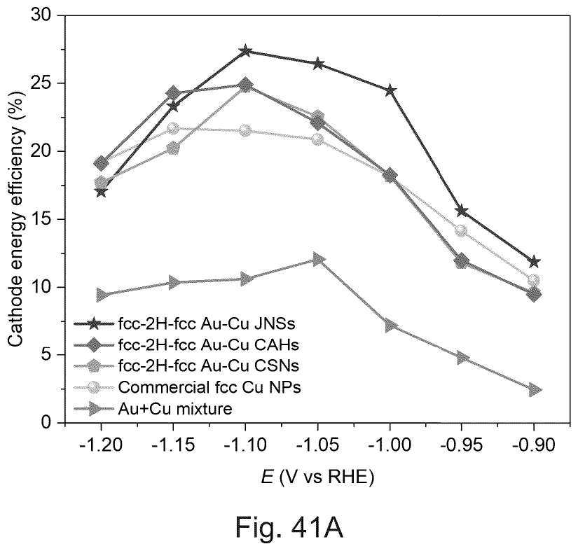

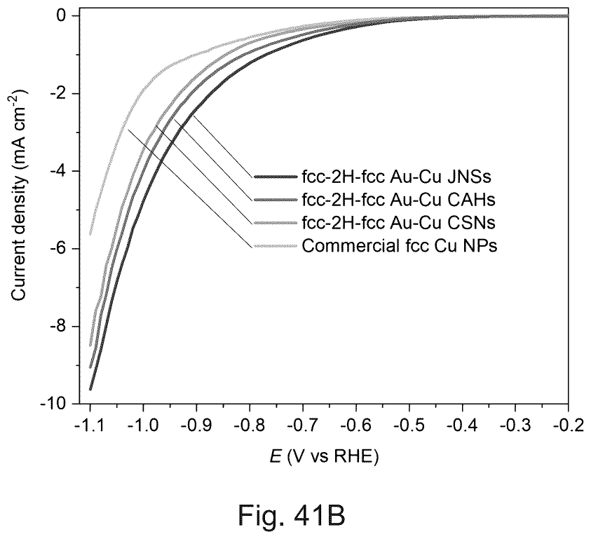

As shown in FIGS. 36A to 36C and FIGS. 37A to 37C, the as-prepared fcc-2H-fcc Au—Cu heteronanostructures with unconventional phase Cu demonstrate excellent performance in CO₂RR, exhibiting the FEC₂H₄ of above 50% at their optimal potentials. Remarkably, fcc-2H-fcc Au—Cu JNSs deliver the highest FEC₂H₄ of 55.5% at −1.1 V (vs RHE). In contrast, the commercial fcc Cu NPs and Au+Cu mixture only present the highest FEC₂H₄ of 44.9% at −1.15 V (vs RHE) and 21.5% at −1.1 V (vs RHE), respectively (FIGS. 38 and 39). The main product obtained on fcc-2H-fcc Au NRs is CO at most of the applied potentials (FIG. 40). Meanwhile, the fcc-2H-fcc Au—Cu JNSs also show a superior cathode energy efficiency (CEE) of 27.4% over the other samples, especially at less negative potentials (FIG. 41A). Besides, based on the linear sweep voltammetry curves, the fcc-2H-fcc Au—Cu JNSs also show the highest current density compared with that of fcc-2H-fcc Au—Cu CAHs, fcc-2H-fcc Au—Cu CSNs and commercial fcc Cu NPs (FIG. 41B), suggesting their outstanding electrocatalytic activity.

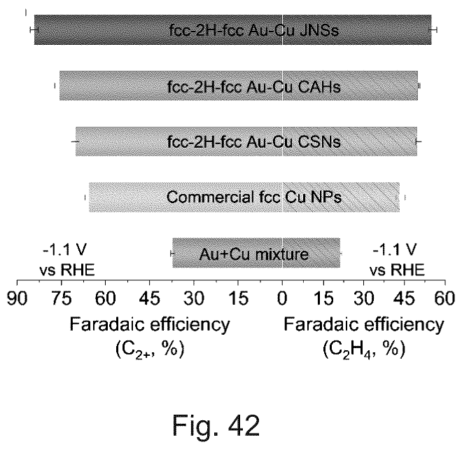

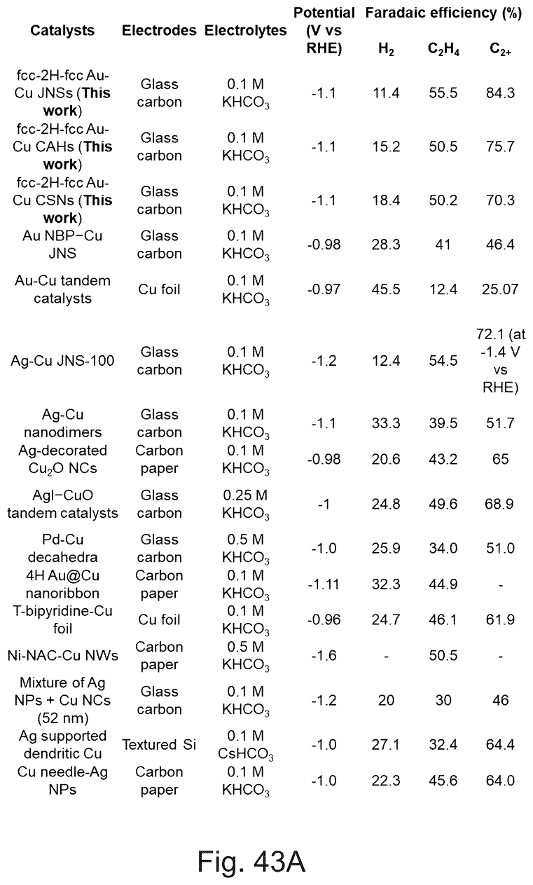

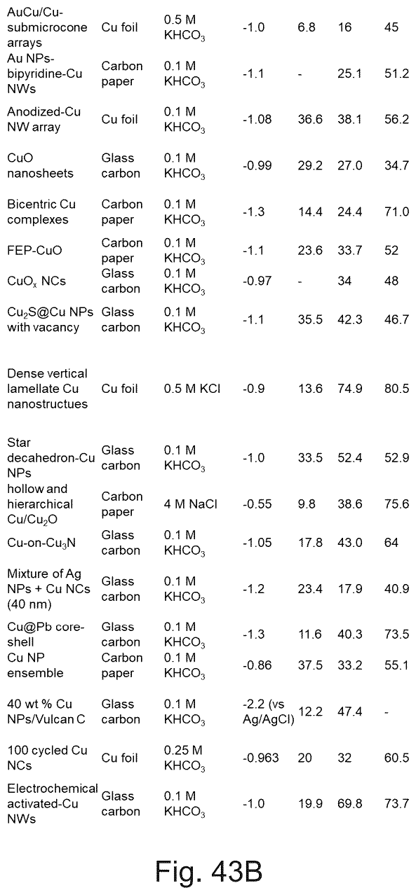

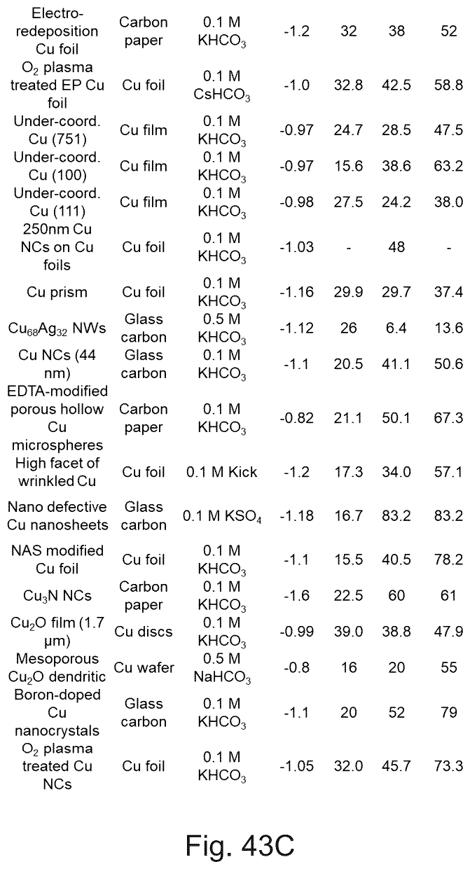

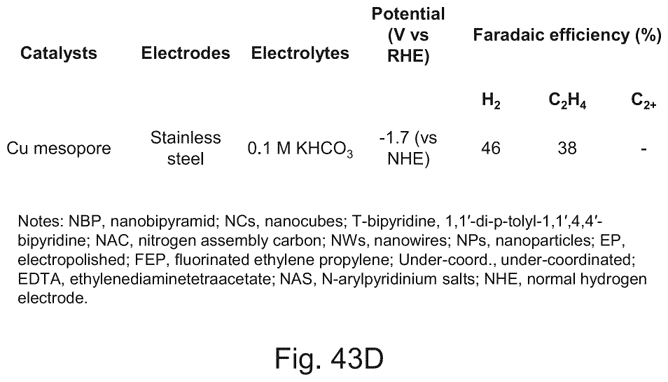

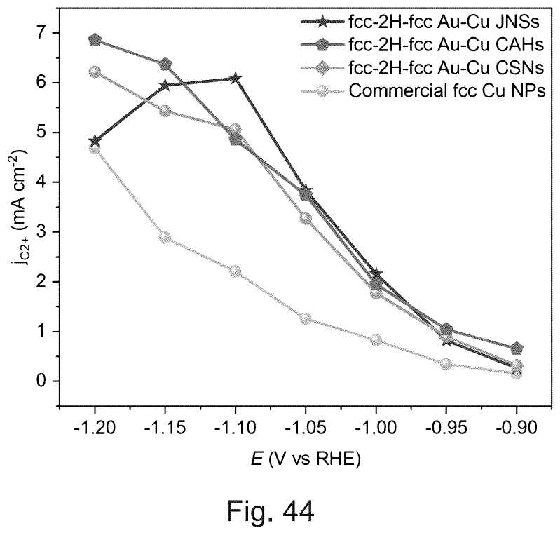

To better tell the CO₂RR performance differences between the fcc-2H-fcc Au—Cu JNSs, fcc-2H-fcc Au—Cu CAHs, fcc-2H-fcc Au—Cu CSNs, commercial fcc Cu NPs and Au+Cu mixture, the FE of them towards C₂₊ products and C₂H₄ are compared and the results are shown in FIG. 42. Significantly, fcc-2H-fcc Au—Cu JNSs show the highest FEs towards both C₂₊ products and C₂H₄ at −1.1 V (vs RHE) among all these samples, i.e., 84.3% and 55.5%, respectively, which also put the fcc-2H-fcc Au—Cu JNSs among the best reported Cu-based CO₂RR catalysts (FIGS. 43A to 43D). In general, the FEs of C₂₊ products and C₂H₄ on different samples have the following order at −1.1 V (vs RHE): fcc-2H-fcc Au—Cu JNSs (84.3%, 55.5%)>fcc-2H-fcc Au—Cu CAHs (75.7%, 50.5%)>fcc-2H-fcc Au—Cu CSNs (70.3%, 50.2%)>commercial fcc Cu NPs (65.7%, 43.6%)>Au+Cu mixture (37.3%, 21.5%). The fcc-2H-fcc Au—Cu JNSs also exhibit the largest partial current density of 6.08 mA cm-2 towards C₂₊ products at −1.1 V (vs RHE), in comparison with fcc-2H-fcc Au—Cu CAHs, fcc-2H-fcc Au—Cu CSNs and commercial fcc Cu NPs (FIG. 44).

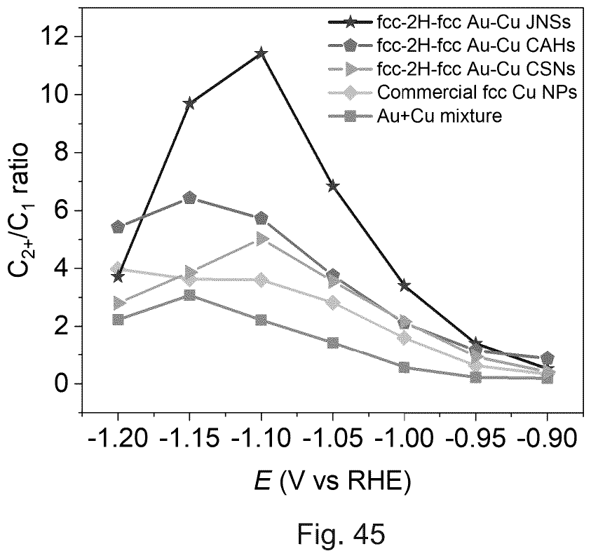

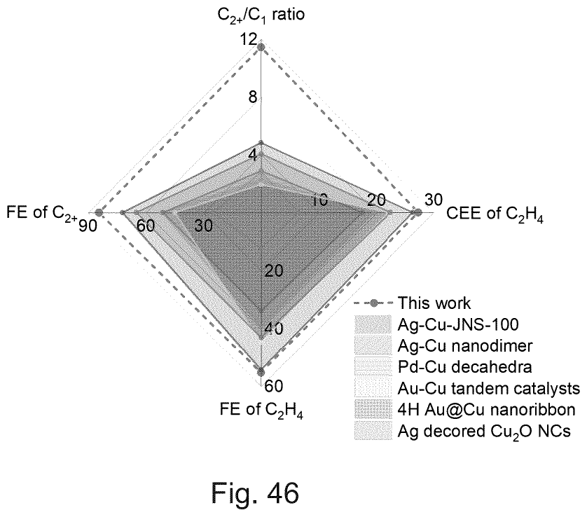

The C₂₊/C₁ product ratios, which can largely reflect the C—C coupling efficiency in CO₂RR, are also compared (FIG. 45). Notably, the fcc-2H-fcc Au—Cu JNSs exhibit the highest C₂₊/C₁ product ratio of 11.4, which is much larger than that of fcc-2H-fcc Au—Cu CAHs (6.4), fcc-2H-fcc Au—Cu CSNs (5.0), commercial fcc Cu NPs (3.6) and Au+Cu mixture (3.1), suggesting the highly efficient C—C coupling process on fcc-2H-fcc Au—Cu JNSs. Furthermore, the CO₂RR performance of fcc-2H-fcc Au—Cu JNSs well outperforms the reported catalysts with similar heterostructures, in four aspects, including the FE of C₂H₄, CEE of C₂H₄, FE of C₂₊ products, and C₂₊/C₁ ratio (FIG. 46).

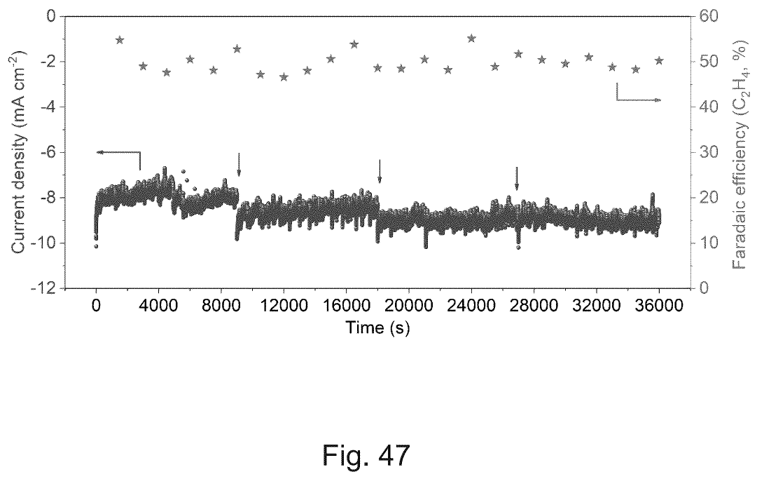

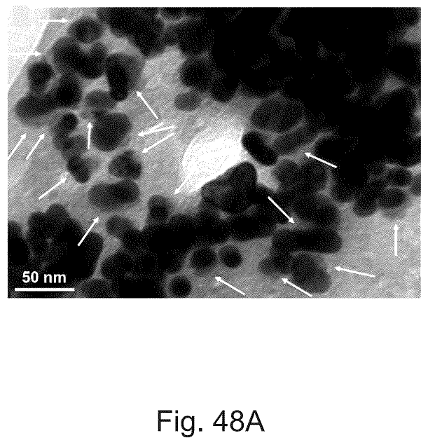

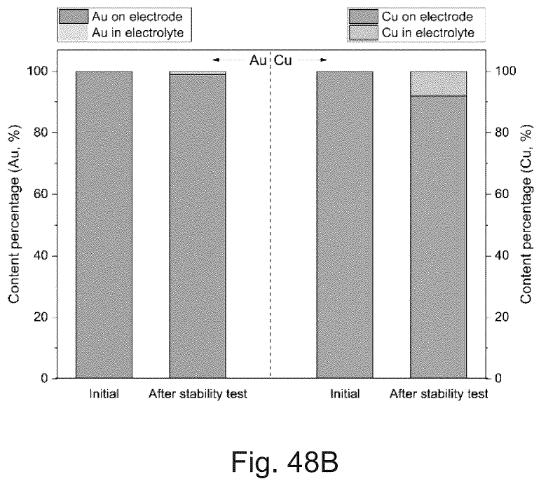

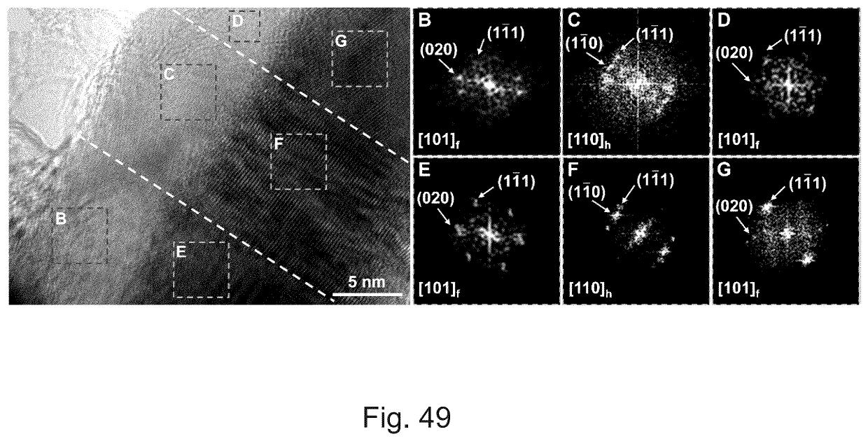

The catalytic stability of fcc-2H-fcc Au—Cu JNSs was evaluated via long-term CO₂ electrolysis in H-type cell at −1.1 V (vs RHE). After 10 h operation, the current density displays no obvious decrease and the FE of C₂H₄ can still reach 50% (FIG. 47). Importantly, after the durability test, the fcc-2H-fcc Au—Cu JNSs can still largely maintain their composition and unique morphology (FIGS. 48A and 48B), as well as the unconventional fcc-2H-fcc heterophase in both Au and Cu domains (FIG. 49). The aforementioned results indicate the excellent catalytic and structural stabilities of fcc-2H-fcc Au—Cu JNSs towards the CO₂ electroreduction.

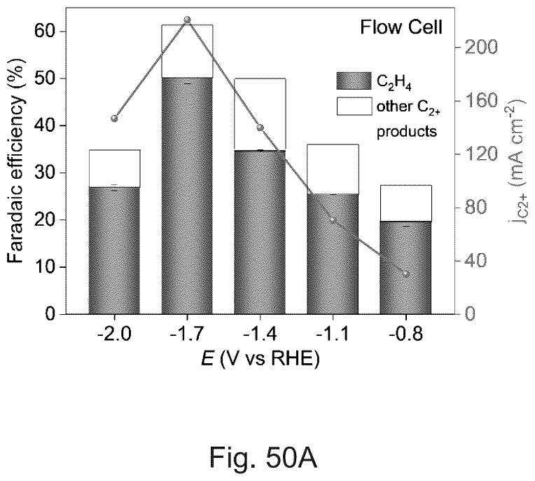

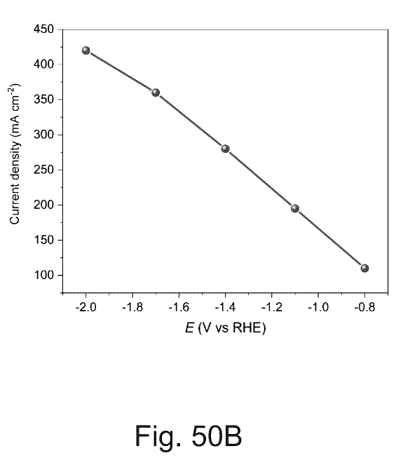

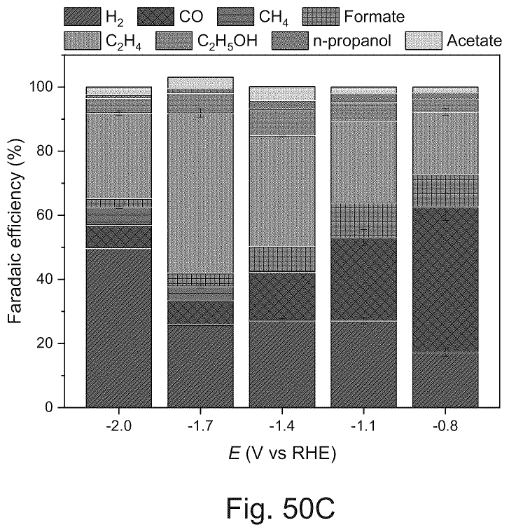

To evaluate the potential of fcc-2H-fcc Au—Cu JNSs as catalyst for practical application, the CO₂RR performance of them was further tested in a flow cell by using 1 M potassium hydroxide (KOH) aqueous solution as electrolyte (FIGS. 50A to 50C). Impressively, fcc-2H-fcc Au—Cu JNSs exhibit the highest FE of 50.1% towards C₂H₄ with a partial current density of 180.5 mA cm⁻² at −1.7 V (vs RHE). Meanwhile, fcc-2H-fcc Au—Cu JNSs achieve the highest FE of 61.3% towards C₂₊ products with the partial current density of 220.8 mA cm⁻² at −1.7 V (vs RHE), exceeding the industrial relevant current density threshold (200 mA cm⁻²). These results reveal the great potential of fcc-2H-fcc Au—Cu JNSs as high-performance catalysts towards the electrochemical CO₂RR to high-value C₂₊ products under practical conditions.

### Example 8

### In-situ Mechanism Studies

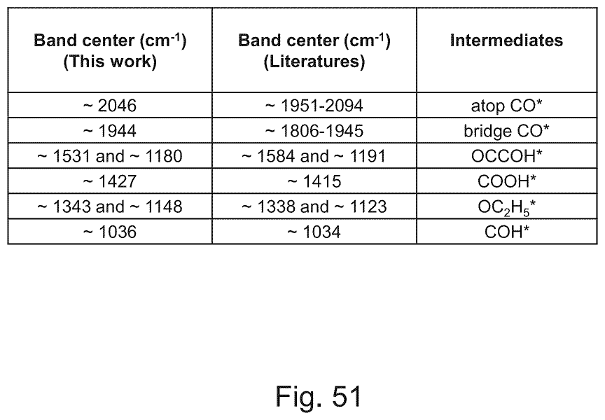

To investigate further to the boosted generation of C₂₊ products on fcc-2H-fcc Au—Cu JNSs, in-situ ATR-FTIR spectroscopy was utilized to monitor and identify the key adsorbed intermediates during electrochemical CO₂RR. Starting from −0.3 V (vs RHE), several peaks were found in the ATR-FTIR spectra, which can be assigned to the corresponding CO₂-reduction intermediates, as shown in FIG. 51. In particular, the peaks at approximately 2046 and 1944 cm⁻¹ are ascribed to the atop and bridge configurations of CO* adsorption on Cu surface, respectively.

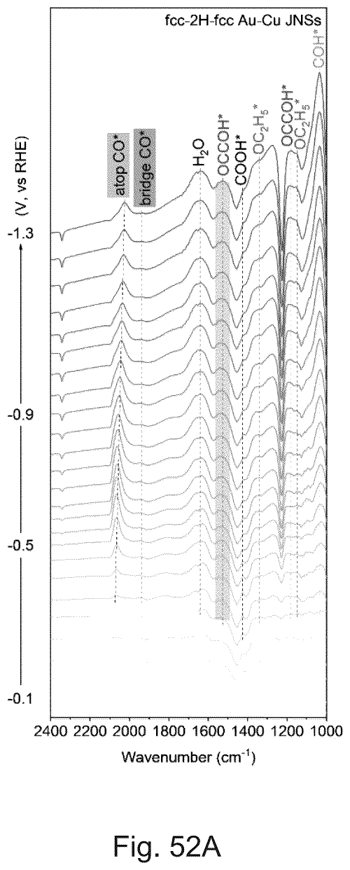

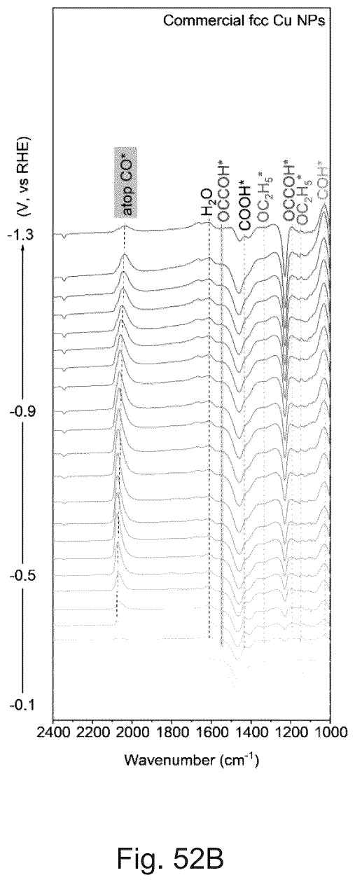

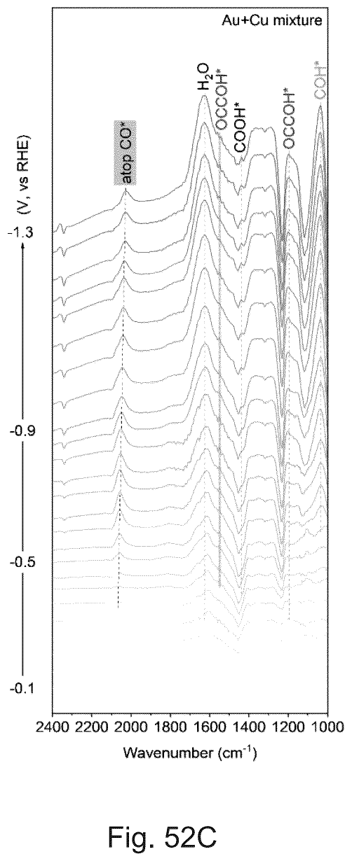

As shown in FIGS. 52A to 52C, compared with the only atop-adsorbed CO* on both commercial fcc Cu NPs and Au+Cu mixture, the appearance of bridge-adsorbed CO* was also observed on fcc-2H-fcc Au—Cu JNSs. This unique bridge-adsorption of CO* on fcc-2H-fcc Au—Cu JNSs might originate from the presence of unconventional phase Au—Cu interface, which does not exist in either commercial fcc Cu NPs or Au+Cu mixture. It is believed that the co-existence of CO* atop and bridge adsorption configurations favors the C—C coupling and thus the successive generation of C₂₊ products. In addition, the peaks of OCCOH* (around 1531 and 1180 cm⁻¹) and OC₂H₅* (about 1343 and 1148 cm⁻¹) on fcc-2H-fcc Au—Cu JNSs are much more pronounced than those on commercial fcc Cu NPs and Au+Cu mixture, especially when comparing the peak of OCCOH* at ca. 1531 cm⁻¹. Note that OCCOH* and OC₂H₅* are critical intermediates for the generation of C₂H₄ and C₂H₅OH in CO₂RR, respectively. This result further verifies that the C—C coupling is enhanced on fcc-2H-fcc Au—Cu JNSs compared with commercial fcc Cu NPs and Au+Cu mixture. These observations suggest that the CO* adsorption configuration is diversified on fcc-2H-fcc Au—Cu JNSs and the reaction pathway is oriented to C₂₊ production via enhanced C—C coupling.

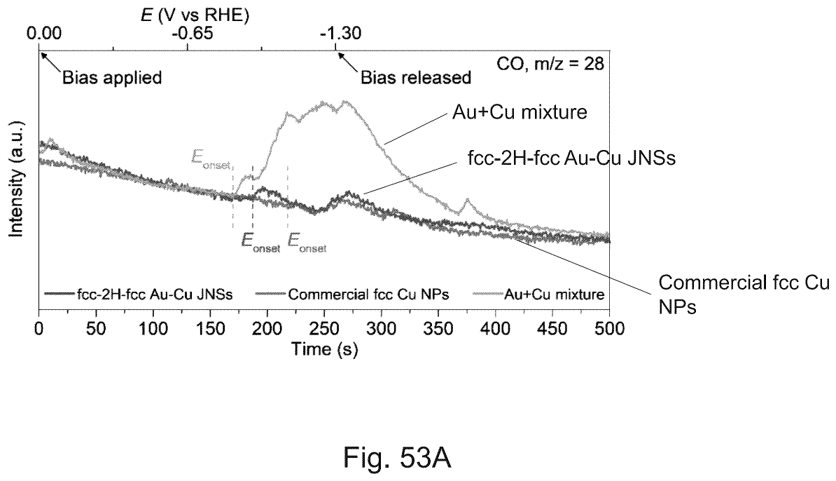

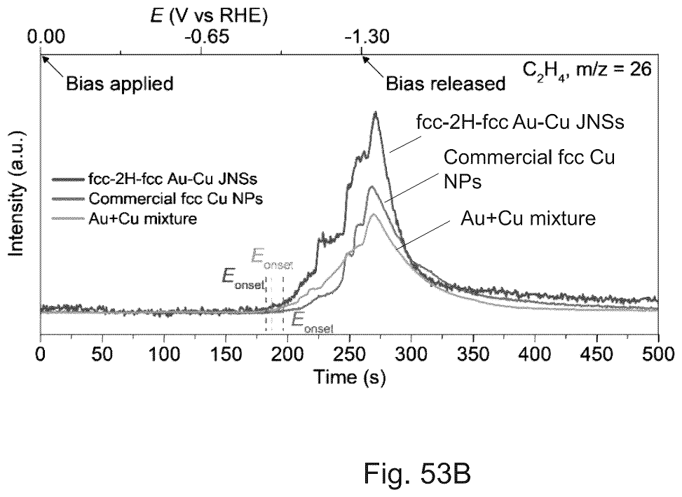

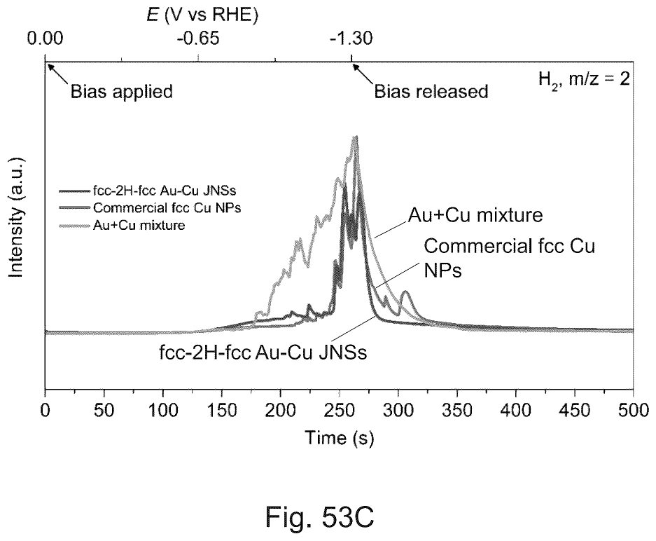

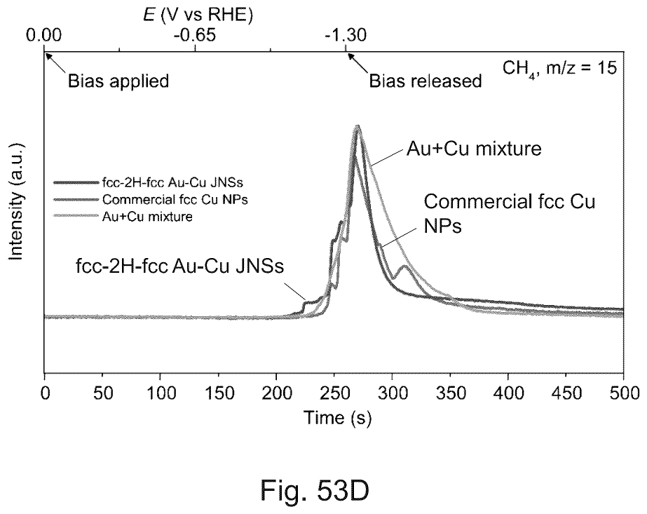

In-situ DEMS was also applied to understand the CO₂-reduction process on fcc-2H-fcc Au—Cu JNSs. The in-situ DEMS spectra of catalysts were collected by linearly sweeping the potential from 0 to −1.3 V (vs RHE) with a scan rate of 5 mV s⁻¹ under CO₂RR conditions. Several peaks were detected in the DEMS spectra, which correspond to H₂, CO, CH₄ and C₂H₄ according to their characteristic m/z values (FIGS. 53A to 53D), respectively. As shown in FIG. 53A, the onset potential of CO on the fcc-2H-fcc Au—Cu JNSs locates between those on the Au+Cu mixture and commercial fcc Cu NPs. This result suggests that the combination of Au with Cu components does help to decrease the overpotential of CO formation, which is the key source/intermediate for C—C coupling. And the delayed observation of CO on the fcc-2H-fcc Au—Cu JNSs than the Au+Cu mixture might arise from the CO spillover from the Au domain to Cu domain. Moreover, for the generation of C₂H₄, fcc-2H-fcc Au—Cu JNSs demonstrate the least negative onset potential, followed by the Au+Cu mixture and then the commercial fcc Cu NPs (FIG. 53B). These findings further reveal that the formation of unconventional phase Au—Cu interface is of great importance to the C₂₊ generation on fcc-2H-fcc Au—Cu JNSs.

### Example 9

### Theoretical Calculations

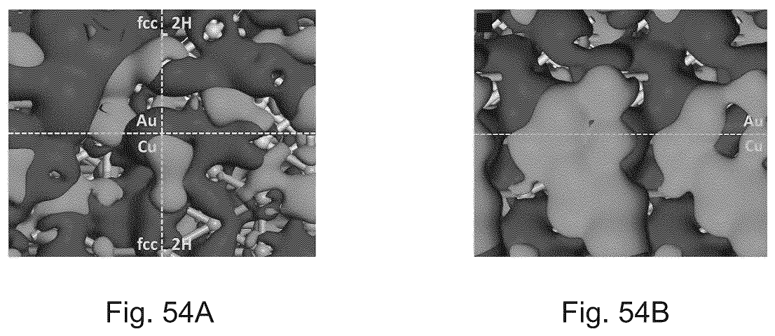

To reveal the influences of the unconventional phase JNSs on CO₂RR performances, density functional theory (DFT) calculations were further applied to investigate the difference in electronic structures and reaction trends between 2H/fcc Au—Cu and fcc Au—Cu JNSs. For the electronic distributions near the Fermi level (EF), the bonding orbital distributions become stronger on the surface of the 2H/fcc Au—Cu JNSs than that of fcc Au—Cu JNSs (FIGS. 54A and 54B). This is induced by the introduction of the unconventional 2H phases, which guarantees efficient electron transfer toward the intermediates. The structure of 2H/fcc Au—Cu JNSs remains stable after relaxations, where only minor lattice distortions are noted. This confirms the stability of the combinations of Janus structures and heterophase structures in the 2H/fcc Au—Cu JNSs.

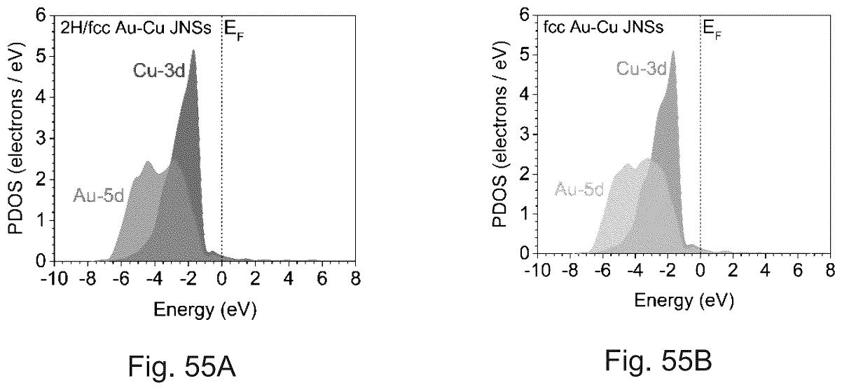

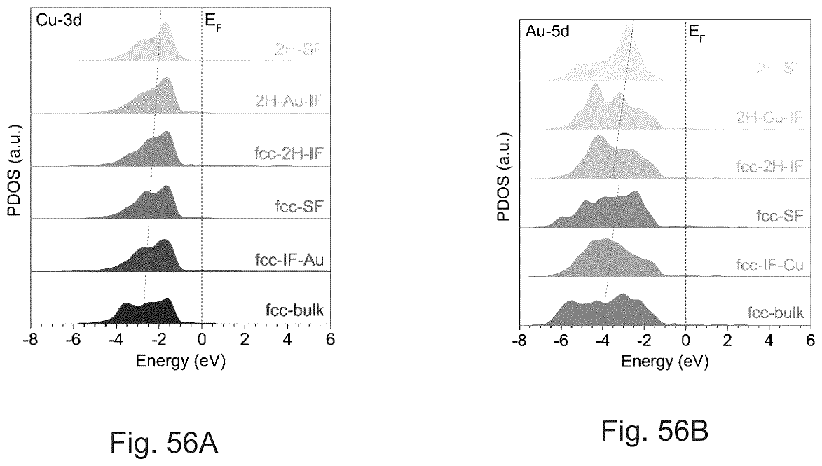

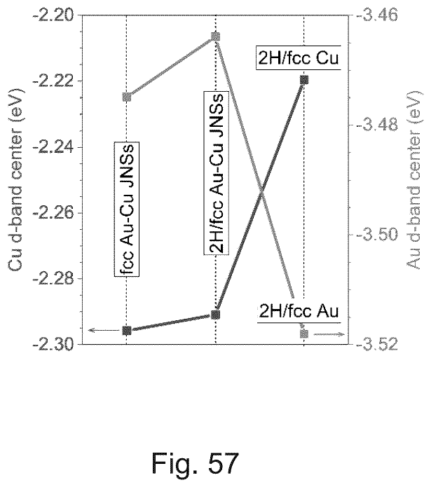

Then the projected partial density of states (PDOSs) of 2H/fcc and fcc Au—Cu JNSs have been further compared (FIGS. 55A and 55B). Notably, the overall electronic structures are not significantly changed by the unique 2H phases, where the Cu-3d orbitals display an evident sharp peak near the EF, which are located in Ev-1.65 eV (Ev denotes 0 eV) and Ev-1.67 eV for 2H/fcc and fcc Au—Cu JNSs, respectively. The Au—5d orbitals are located in deeper positions with broad coverage from Ev-1.0 eV to Ev-7.0 eV. Such electron-rich features indicate that the Au domains play as the electron reservoir to support the electron transfer through Cu sites to the intermediates. Although the overall PDOSs show limited changes, further investigations of the site-dependent PDOSs demonstrate the influences of the Janus structures and heterophase. For Cu sites, a gradual upshifting of the 3d orbitals from the fcc bulk to the 2H surface is observed (FIG. 56A). Compared to the fcc phases, the overall Cu-3d orbitals are upshifted, which demonstrates that the 2H phases are critical to improve the electroactivity of Cu sites for CO₂RR processes. In comparison, the electronic structure evolutions in Au-5d orbitals are also evident (FIG. 56B). For the fcc phases, the Au-5d orbitals have been upshifted from bulk to the surfaces, which is attributed to the coordination environment changes.

For the surface sites on 2H phases, the interface with Au-fcc phases exhibits the lowest electroactivity while pristine 2H surface sites display an evident peak with improved electroactivity. The site-dependent PDOSs have confirmed that the 2H phases are the key active sites to promote CO₂RR performances. The d-band centers of both Cu-3d and Au-5d orbitals are further compared (FIG. 57). For Cu sites, the 2H/fcc Au—Cu JNSs have exhibited a higher d-band center than the fcc Au—Cu JNSs, which is ascribed to the formation of highly electroactive 2H phases. More importantly, it is noted that the pristine 2H/fcc Cu shows an even higher d-band center, which further confirms that the superior electroactivity is mostly determined by the 2H phase of Cu. In the meantime, Au-5d orbitals deliver a different trend of the d-band center, where the 2H/fcc Au—Cu JNSs show a higher d-band center than both fcc Au—Cu and 2H/fcc Au. This proves that the improved electroactivity of Au-5d orbitals originates from the interactions between 2H Cu and 2H Au, which also benefit the overall electroactivity in 2H/fcc Au—Cu JNSs.

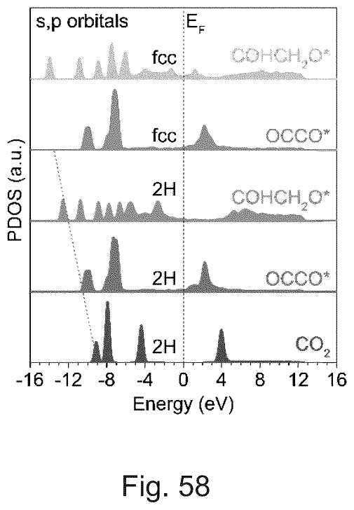

Besides the electronic structures of the metal sites, the PDOSs of key adsorbates for the formation of C₂H₄ are also revealed (FIG. 58). For the 2H surface, the s,p orbitals of intermediates show a good linear correlation from initial CO₂ to C—C coupling and the following hydrogenation, where the downshifting of the s,p orbitals supply an efficient reduction process. In contrast, the s,p orbitals indicate a much weakened linear relationship on the fcc surface, which potentially induces higher energy barriers for the reduction process.

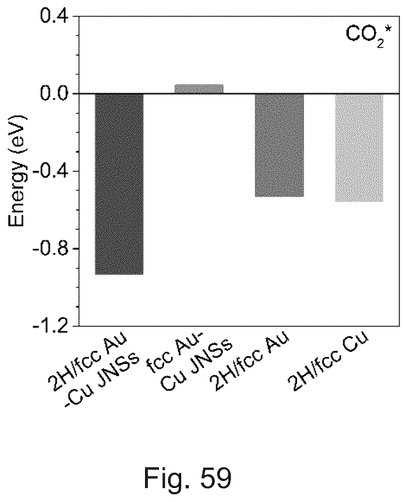

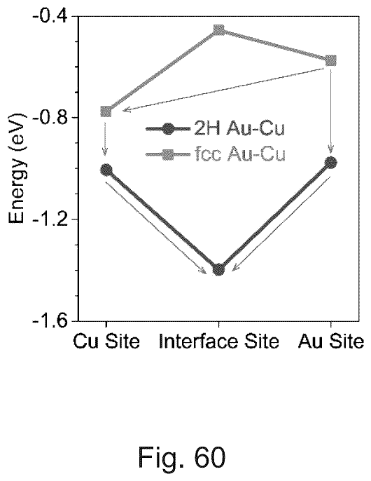

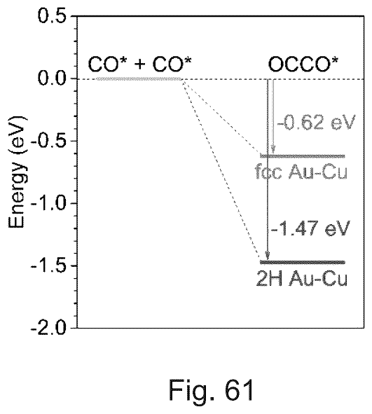

Theoretical investigations of CO₂ reduction processes were also carried out from energetic perspectives. The adsorption of initial reactant CO₂ is strongest on the 2H/fcc Au—Cu JNSs, especially near the 2H interface between Au and Cu (FIG. 59). Notably, the fcc Au—Cu JNSs display much weaker preferences for CO₂ adsorption even compared to 2H/fcc Au and 2H/fcc Cu. These results suggest that the introduction of the 2H phase is important to improve the adsorption preferences of CO₂. As the key intermediate for C—C coupling, the adsorption of CO* is another important criterion (FIG. 60). It is noted that the fcc phases and 2H phases indicate different CO spillover trends. The CO* prefers to migrate from fcc Au to fcc Cu with an energy barrier at the fcc Au/Cu interface. However, CO* on both 2H Cu and 2H Au tends to migrate to the 2H Au/Cu interface, supporting that the unconventional phase Au/Cu interface is the potential active site to promote C—C coupling and the generation of C₂₊ products. The large energy differences on the 2H phases also guarantee the more efficient spillover of CO*. The CO* spillover from fcc to 2H phases is also possible due to the higher energetically preferences for Cu, Au, and interface sites. The flexible CO* spillover ways guarantee the efficient C—C coupling on 2H/fcc Au—Cu JNSs (FIG. 61). Accordingly, owing to the improved CO* adsorption, the C—C couplings on 2H/fcc Au—Cu JNSs show an evidently stronger trend than that on fcc Au—Cu JNSs, which leads to higher FE of C₂₊ products.

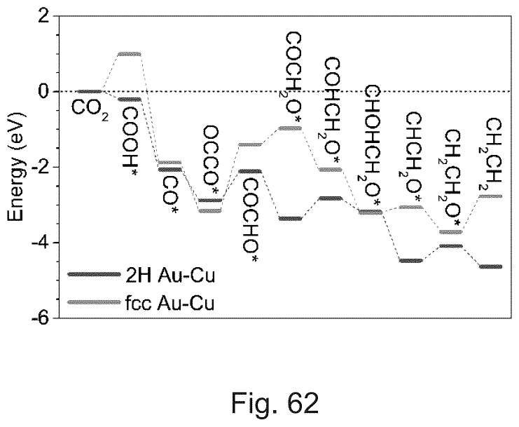

To reveal the overall reaction trends, the reaction trend of C₂H₄ generation is compared on 2H Au—Cu and fcc Au—Cu (FIG. 62). The 2H Au—Cu has much alleviated energy barriers of CO₂RR, where the rate-determining step (RDS) is the hydrogenation of OCCO* with an energy barrier of 0.77 eV. The fcc Au—Cu has the same RDS with a greatly enlarged energy barrier of 1.76 eV, which significantly lowers the efficiency of the C₂H₄ generation. Moreover, the formation of CO* on fcc Au—Cu JNSs also has an energy barrier of 1.0 eV from CO₂ to COOH*, which hinders the C—C coupling, resulting in a reduced selectivity of the C₂₊ products. The overall reaction energy of 2H Au—Cu is lowered than that of fcc Au—Cu, supporting the enhanced electroactivity towards the C₂₊ products. These results well rationalize the structural advantages of fcc-2H-fcc Au—Cu JNSs in facilitating the efficient conversion of CO₂ to high-value C₂₊ products.

The invention has been given by way of example only, and various other modifications of and/or alterations to the described embodiment may be made by persons skilled in the art without departing from the scope of the invention as specified in the appended claims.

1. A nanomaterial comprising:
an Au nanostructure; and
a Cu nanostructure provided with the Au nanostructure;
wherein each of the Au nanostructure and the Cu nanostructure is in the form of a heterophase.

2. The nanomaterial as claimed in claim 1, wherein the Cu nanostructure is provided on and above the Au nanostructure.

3. The nanomaterial as claimed in claim 1, wherein both the Au nanostructure and the Cu nanostructure are in the form of a fcc-2H-fcc heterophase structure.

4. The nanomaterial as claimed in claim 1, wherein the Cu nanostructure covers a first portion of the Au nanostructure.

5. The nanomaterial as claimed in claim 4, wherein a second portion of the Au nanostructure is covered by a surfactant.

6. The nanomaterial as claimed in claim 1, wherein the Au nanostructure is in the form of a fcc-2H-fcc Au nanorod.

7. The nanomaterial as claimed in claim 6, wherein the fcc-2H-fcc Au nanorod has a first portion being covered by a fcc-2H-fcc Cu nanostructure.

8. The nanomaterial as claimed in claim 7, wherein the fcc-2H-fcc Au nanorod and the fcc-2H-fcc Cu nanostructure are arranged in a substantially lattice-matching manner.

9. The nanomaterial as claimed in claim 7, wherein the fcc-2H-fcc Au nanorod includes a second portion at least partly covered by a surfactant.

10. The nanomaterial as claimed in claim 9, wherein the surfactant comprises any one of oleylamine and dodecylamine.

11. The nanomaterial as claimed in claim 1, wherein the fcc-2H-fcc Au nanostructure and the fcc-2H-fcc Cu nanostructure are arranged in the form of a Janus nanostructure.

12. The nanomaterial as claimed in claim 7, wherein the first portion of fcc-2H-fcc Au nanorod is circumferentially covered by the fcc-2H-fcc Cu nanostructure.

13. The nanomaterial as claimed in claim 10, wherein the first portion is arranged between two second portions on the fcc-2H-fcc Au nanorod, and at least one of the two second portions is at least partly covered by the surfactant.

14. The nanomaterial as claimed in claim 13, wherein at least one of the two second portions is at least partly covered by fcc Cu atoms of the fcc-2H-fcc Cu nanostructure.

15. The nanomaterial as claimed in claim 14, wherein the fcc-2H-fcc Au nanorod and the fcc-2H-fcc Cu nanostructure are arranged in the form of a co-axial heteronanostructure.

16. The nanomaterial as claimed in claim 6, wherein the fcc-2H-fcc Au nanorod is enclosed by the fcc-2H-fcc Cu nanostructure.

17. The nanomaterial as claimed in claim 16, wherein the fcc-2H-fcc Au nanorod and the fcc-2H-fcc Cu nanostructure are arranged in the form of a fcc-2H-fcc Au—Cu core-shell nanostructure.

18. A method for preparing the nanomaterial as claimed in claim 1, comprising the steps of:
a) providing a reaction mixture comprising a fcc-2H-fcc Au nanostructure, a reductant, and a copper precursor;
b) heating the reaction mixture for a predetermined time, followed by cooling the reaction mixture to room temperature; and
c) isolating the nanomaterial from the reaction mixture.

19. The method as claimed in claim 18, wherein the reaction mixture further includes a surfactant.

20. The method as claimed in claim 19, wherein the reaction mixture is provided by adding the copper precursor, at an elevated temperature, to a solution mixture including the fcc-2H-fcc Au nanostructure, the surfactant, and the reductant at a predetermined rate.

21. The method as claimed in claim 18, wherein the reductant comprises any one of 1,2-hexanediol, 1,2-hexadecanediol and 1,2-butanediol.

22. The method as claimed in claim 19, wherein the surfactant comprises a mixture of oleylamine and dodecylamine.

23. The method as claimed in claim 22, wherein oleylamine and dodecylamine have a volume ratio of about 2:3.

24. The method as claimed in claim 18, wherein the copper precursor comprises copper acetylacetone.

25. The method as claimed in claim 20, wherein the copper precursor is added to the solution mixture at a rate of about 0.094 mL min⁻¹ when the reductant comprises 1,2-hexanediol.

26. The method as claimed in claim 20, wherein the copper precursor is added to the solution mixture at a rate of about 0.062 mL min⁻¹ when the reductant comprises 2-hexadecanediol.

27. The method as claimed in claim 20, wherein the copper precursor is added to the solution mixture at a rate of about 0.5 mL min⁻¹ when the reductant comprises 1,2-butanediol.

28. The method as claimed in claim 20, wherein the elevated temperature is about 110° C. to about 130° C.

29. The method as claimed in claim 18, wherein the fcc-2H-fcc Au nanostructure is provided in the form of a fcc-2H-fcc Au nanorod.

30. The method as claimed in claim 18 is a seeded growth method.
